(19) United States
(12) Patent Application Publication
(10) Pub. No.: US 2026/0244968 A1
(43) Pub. Date: Aug. 20, 2026

(54) Long-Range Quantum Interactions via Multi-Mode Qubits

(71) Applicant: International Business Machines Corporation, Armonk, NY (US)

(72) Inventors: Timothy PHUNG, Milpitas, CA (US); Kentaro HEYA, White Plains, NY (US); Moein MALEK, Elmsford, NY (US); Aaron FINCK, White Plains, NY (US); Muir KUMPH, Croton on Hudson, NY (US)

(21) Appl. No.: 19/058,523

(22) Filed: Feb. 20, 2025

(51) Int. Cl. G06N 10/40; G06N 10/20

(52) U.S. Cl. CPC G06N 10/40; G06N 10/20

(57) ABSTRACT

Systems/techniques that facilitate long-range quantum interaction via multi-mode qubits are provided. In various embodiments, a device can include two multi-mode qubits coupled by a cable. In various aspects, the two multi-mode qubits can have a first excitation mode and a second excitation mode. In various instances, a dipole moment symmetry of the cable can align with that of the second excitation mode. In various cases, the device can include a signal generator that can transmit a quantum state between the two multi-mode qubits, based on biasing the two multi-mode qubits from the first excitation mode toward the second excitation mode.

### BACKGROUND

Facilitating long-range quantum interactions between qubits can be difficult.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus, or computer program products that can facilitate long-range quantum interactions via multi-mode qubits are described.

According to one or more embodiments, a device is provided. In various aspects, the device can include two multi-mode qubits coupled by a cable, wherein the two multi-mode qubits can have a first excitation mode and a second excitation mode, and wherein a dipole moment symmetry of the cable can align with that of the second excitation mode. In various instances, the device can include a signal generator that can transmit a quantum state between the two multi-mode qubits, based on biasing the two multi-mode qubits from the first excitation mode toward the second excitation mode.

According to one or more embodiments, a method is provided. In various aspects, the method can include transmitting a quantum state between two multi-mode qubits having a first excitation mode and a second excitation mode, wherein the two multi-mode qubits can be coupled by a cable whose dipole moment symmetry aligns with that of the second excitation mode. In various instances, the transmitting can include: biasing, via a signal generator, the two multi-mode qubits from the first excitation mode toward the second excitation mode.

According to one or more embodiments, a method is provided. In various aspects, the method can include transmitting a quantum state between two multi-mode qubits having a first excitation mode and a second excitation mode, wherein the two multi-mode qubits can be coupled by a cable whose dipole moment symmetry aligns with that of the second excitation mode. In various instances, the transmitting can include switching, via a signal generator, the dipole moment symmetry of the cable such that it aligns with that of the first excitation mode.

### DESCRIPTION OF THE DRAWINGS

FIG. 1 illustrates a block diagram of an example, non-limiting system that facilitates long-range quantum interaction via multi-mode qubits in accordance with one or more embodiments described herein.

FIGS. 2-3 illustrate example, non-limiting structural diagrams showing how a dipole moment symmetry of a multi-mode qubit can match or not match that of a cable in accordance with one or more embodiments described herein.

FIGS. 4-7 illustrate example, non-limiting block diagrams showing how mode-switching can be implemented to facilitate a state transfer between two multi-mode qubits in accordance with one or more embodiments described herein.

FIGS. 8-9 illustrate example, non-limiting experimental results regarding state transfer induced via mode-switching in accordance with various embodiments described herein.

FIG. 10 illustrates an example, non-limiting structural diagram showing how a tunable coupler qubit having superconducting quantum interference device (SQUID) loops instead of single Josephson junctions can be leveraged to facilitate a state transfer in accordance with one or more embodiments described herein.

FIGS. 11-14 illustrate example, non-limiting experimental results regarding state transfer induced via SQUID loop de-balancing in accordance with various embodiments described herein.

FIG. 15 illustrates an example, non-limiting block diagram showing how fully remote quantum gates can be accomplished via cable driving in accordance with one or more embodiments described herein.

FIG. 16 illustrates example, non-limiting experimental results regarding remote quantum gates performed via cable driving in accordance with various embodiments described herein.

FIG. 17 illustrates a flow diagram of an example, non-limiting method that facilitates long-range quantum interaction via multi-mode qubits in accordance with one or more embodiments described herein.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computing can be facilitated by performing quantum circuits (e.g., sequences of parallel or serial quantum gates, such as Pauli-X gates, Pauli-Y gates, Pauli-Z gates, Phase gates, Controlled Not gates, or Controlled Phase gates) on qubits (e.g., superconducting qubits, such as transmon qubits) that are arranged within a qubit lattice. The types or content of quantum circuits that can be performed on the qubit lattice can depend upon which qubits are coupled to each other within the qubit lattice. For example, an entangling gate (e.g., a Controlled Not gate, a Controlled Phase gate) can be performed only on two qubits that are coupled together and cannot be performed on any two qubits that are not coupled together. In this way, the quantum circuits that are implementable on the qubit lattice can be restricted by the coupling topology of the qubit lattice.

Usually, qubits that are coupled to each other within a qubit lattice are immediately adjacent to or otherwise within physical proximity of each other (e.g., within mere millimeters or micrometers of each other). Thus, quantum interactions are generally unable to occur between qubits that are physically far apart from each other (e.g., between qubits that are half a meter, one meter, or even more away from each other). To increase the scalability of quantum computing, it can be desired to couple together two qubits that are physically far apart from each other. Unfortunately, existing techniques do not know how to accomplish such coupling with a long-range cable without suffering from excessive fidelity losses.

Accordingly, systems or techniques that can facilitate long-range quantum interactions with no or reduced fidelity losses can be desirable.

Various embodiments described herein can address one or more of these technical problems. In particular, various embodiments described herein can provide systems or techniques that can facilitate long-range quantum interactions via multi-mode qubits. A multi-mode qubit, such as a tunable coupler qubit (TCQ), can be a qubit that can represent quantum states using more than one excitation mode. For example, when operating in some particular excitation mode, the quantum state of the multi-mode qubit can be considered as being exhibited or otherwise manifested by a particular physical or electromagnetic behavior of the multi-mode qubit. In contrast, when operating in a different excitation mode, the quantum state of the multi-mode qubit can instead be considered as being exhibited or otherwise manifested by a different physical or electromagnetic behavior of the multi-mode qubit. In other words, a quantum state can be considered as an information payload that is carried by the multi-mode qubit, and different excitation modes can be considered as different ways in which the multi-mode qubit can physically or electromagnetically represent that information payload. In any case, the inventors of various embodiments described herein realized that multi-mode qubits can be implemented so as to facilitate long-range quantum interactions without (or otherwise with significantly reduced versions of) the fidelity losses which are considered unavoidable by existing teachings.

More specifically, the present inventors recognized that each excitation mode of a multi-mode qubit can be considered as exhibiting a respective dipole moment symmetry (e.g., a respective electromagnetic field profile or direction of charge flow). The present inventors further recognized that a long-range cable can likewise be considered as exhibiting its own dipole moment symmetry. The present inventors realized that, if a long-range cable coupling two far-apart multi-mode qubits is constructed so as to have a dipole moment symmetry that matches that of one excitation mode of those two multi-mode qubits, then reduced-loss quantum interactions can be performed between those two multi-mode qubits even though they are located physically far apart.

As an example, a state transfer from one of those two multi-mode qubits to the other can be facilitated via mode-switching. In particular, normal operation or quantum processing can be facilitated while those two multi-mode qubits are in an excitation mode whose dipole moment symmetry does not match that of the long-range cable, and a quantum state transfer between those two multi-mode qubits can be selectively performed by switching them to whichever excitation mode whose dipole moment symmetry matches that of the long-range cable.

As another example, a state transfer from one of those two multi-mode qubits to the other can be facilitated via inductance de-balancing. In particular, each of those two multi-mode qubits can be a TCQ having respective superconducting quantum interference device (SQUID) loops instead of single Josephson junctions. Normal operation or quantum processing can be facilitated while those two multi-mode qubits are in an excitation mode whose dipole moment symmetry does not match that of the long-range cable and while inductances of the SQUID loops are balanced (e.g., equal to each other), and a quantum state transfer between those two multi-mode qubits can be selectively performed by de-balancing (e.g., making unequal) the inductances of the SQUID loops.

As yet another example, a remote entangling gate can be performed on those two multi-mode qubits via cable-driving. In particular, the long-range cable can be exposed to a microwave pulse while those two multi-mode qubits are in an excitation mode whose dipole moment symmetry matches that of the long-range cable. This can cause the quantum states of those two multi-mode qubits to undergo whatever gate or transformation corresponds to the frequency of the microwave pulse, even though those two multi-mode qubits are not themselves being driven by (e.g., are not being directly exposed to) local microwave pulses.

In any of such situations, an amount of fidelity loss associated with whatever quantum interaction (e.g., state transfer, remote gate) is occurring between the two far-apart multi-mode qubits can be lower than that which would occur between two far-apart single-mode qubits. Accordingly, various embodiments described herein can be considered as leveraging multi-mode qubits so as to reduce losses associated with long-range quantum interactions.

Various embodiments described herein can be considered as systems, devices, or methods, or apparatuses for facilitating long-range quantum interactions via multi-mode qubits. In various embodiments, a system can include or otherwise be made up of a first multi-mode qubit, a second multi-mode qubit, a cable, and a signal generator.

In various aspects, the first and second multi-mode qubits can be TCQs. In some instances, a TCQ can be a superconducting qubit that includes two capacitively-shunted Josephson junctions that are coupled in series (e.g., a TCQ can be formed by two single-junction transmon qubits that share a planar capacitor pad). In other words, a TCQ can include a first Josephson junction and a second Josephson junction, where the first Josephson junction is serially coupled between a first capacitor pad and a second capacitor pad, and where the second Josephson junction is serially coupled between the second capacitor pad and a third capacitor pad. In various aspects, the second capacitor pad can be called a middle capacitor pad of the TCQ, and the first capacitor pad and the third capacitor pad can be called end capacitor pads of the TCQ. In various cases, a TCQ can also be referred to as a two-junction transmon qubit.

In various instances, a TCQ can support or exhibit two distinct excitation modes: an A mode and a B mode. In various aspects, these two distinct excitation modes can have two different dipole moment symmetries. Without loss of generality, the A mode can have the following dipole moment symmetry: the middle capacitor pad of the TCQ can be neutrally charged; one end capacitor pad of the TCQ can be positively charged; and the remaining end capacitor pad of the TCQ can be negatively charged. In contrast, the B mode can have the following dipole moment symmetry: the middle capacitor pad of the TCQ can be positively charged; and the end capacitor pads of the TCQ can be negatively charged. Accordingly, the A mode and the B mode can be considered as being different ways in which the TCQ can physically or electromagnetically represent quantum information. In various cases, the TCQ can have a respective quantum state transition frequency for each excitation mode. For example, when the TCQ is encoded in the A mode, the TCQ can be considered as having an A mode transition frequency which causes the TCQ to transition between its |0) state and its |1) state. On the other hand, when the TCQ is encoded in the B mode, the TCQ can be considered as having a B mode transition frequency which causes the TCQ to transition between its |0) state and its |1) state, where the B mode transition frequency is different from or not equal to the A mode transition frequency. In various aspects, short microwave pulses can be used to switch the TCQ between the A mode and the B mode. Likewise, when the TCQ is encoded in any given excitation mode, short microwave pulses can be used to manipulate or transform the quantum state as represented or manifested in that given excitation mode.

In various embodiments, the first and second multi-mode qubits can be physically located far from each other (e.g., at least one meter apart, at least half a meter apart). Despite such physical separation, the first and second multi-mode qubits can be coupled together by the cable. In some aspects, such coupling can be capacitive, inductive, or galvanic. In any case, the cable can be any suitable superconducting wire exhibiting a dipole moment symmetry that matches that of either the A mode or the B mode. Without loss of generality, the dipole moment symmetry of the cable can match or otherwise be the same as that of the B mode. As a non-limiting example, the cable can be a coplanar waveguide that is made up of a central conductor sandwiched between two ground planes. In various instances, the central conductor can be positively charged, and the two ground planes can each be negatively charged. As another non-limiting example, the cable can be a coaxial channel that is made up of a conductive core sheathed within a conductive shield. In various aspects, the conductive core can be positively charged, and the conductive shield can be negatively charged. In any case, because the dipole moment symmetry of the cable can match that of the B mode, the cable can be able to “see” or otherwise interact with quantum information that is encoded in the B mode with no (or at most negligible) loss. In contrast, because the dipole moment system of the cable can be mismatched with that of the A mode, the cable cannot “see” and cannot otherwise interact with quantum information that is encoded in the A mode.

In various embodiments, the signal generator can be any suitable device or apparatus that can electronically generate oscillating waveforms or pulses. In situations where the two multi-mode qubits and the cable are physically located within a cryogenic temperature chamber, the signal generator can, in various aspects, also be physically located within the cryogenic temperature chamber (e.g., some oscillating waveform generators have been designed so as to operate in fully programmable fashion at cryogenic temperatures without risking qubit destabilization). In other aspects, however, the signal generator can instead be physically located outside of the cryogenic temperature chamber (e.g., can be located at room-temperature, can be located in any suitable intermediate temperature stage), and an output port of the signal generator can be outfitted with any suitable sequence or series of signal attenuators (e.g., broadside-coupled attenuators). In any case, the signal generator can be electronically coupled via any suitable superconducting wires to the two multi-mode qubits and to the cable. Thus, the signal generator can be able to independently drive each of the two multi-mode qubits or the cable with distinct or respective microwave pulses.

In various embodiments, the signal generator can perform or otherwise facilitate a quantum interaction between the two multi-mode qubits, by manipulating or otherwise leveraging the excitation modes of the two multi-mode qubits.

As a non-limiting example, the signal generator can perform or otherwise facilitate a state transfer from the first multi-mode qubit to the second multi-mode qubit, based on mode-switching. Suppose that the first and second multi-mode qubits are each initially encoded in the A mode. Furthermore, suppose that the first and second multi-mode qubits are each initially in the |0) state. In various aspects, any suitable combination or sequence of quantum gates can be applied to the first multi-mode qubit, thereby transforming its initial |0) state into some resultant quantum state (e.g., some superposition of |0) and |1)). Because the first and second multi-mode qubits are in the A mode, and because the dipole moment symmetry of the A mode does not match that of the cable, the first and second multi-mode qubits can be considered as being electrically isolated from each other, notwithstanding being coupled together by the cable. Thus, the second multi-mode qubit cannot “see” the resultant quantum state that is currently stored in the first multi-mode qubit. In various instances, the signal generator can drive the first multi-mode qubit with whatever microwave pulses are known or deemed to cause a switch from the A mode to the B mode. Due to such driving, the first multi-mode qubit can be encoded in the B mode rather than in the A mode. In other words, prior to such driving, the resultant quantum state was occupying or populating the A mode of the first multi-mode qubit, whereas, after such driving, the resultant quantum state is instead occupying or populating the B mode of the first multi-mode qubit. In various cases, the signal generator can likewise drive the second multi-mode qubit with those microwave pulses, thereby causing the second multi-mode qubit to switch from the A mode to the B mode. At such point, both the first and second multi-mode qubits can be encoded in the B mode. Because the first and second multi-mode qubits are each in the B mode, and because the dipole moment symmetry of the B mode matches that of the cable, the first and second multi-mode qubits can now interact with each other. Specifically, the resultant quantum state that is stored within the first multi-mode qubit can be considered as traveling or propagating with no or negligible loss across the cable toward the second multi-mode qubit. Upon reaching the second multi-mode qubit, the resultant quantum state can be considered as adding to, incrementing, or otherwise combining with the current state of the second multi-mode qubit. Since the current state of the second multi-mode qubit is its initial |0) state, this can cause the second multi-mode qubit to now exhibit the resultant quantum state (e.g., analogous to adding x to 0 for any suitable real number x). Conversely, the initial |0) state that is stored within the second multi-mode qubit can be considered as counter-traveling or counter-propagating with no or negligible loss across the cable toward the first multi-mode qubit. Upon reaching the first multi-mode qubit, that initial |0) state can be considered as adding to, incrementing, or otherwise combining with the current state of the first multi-mode qubit. Because the current state of the first multi-mode qubit can be the resultant quantum state, this can cause the first multi-mode qubit to still exhibit the resultant quantum state (e.g., analogous to adding 0 to x). By switching from the A mode to the B mode in this fashion, the resultant quantum state can thus be transferred from the first multi-mode qubit to the second multi-mode qubit without excessive fidelity loss.

As another non-limiting example, the signal generator can perform or otherwise facilitate a state transfer from the first multi-mode qubit to the second multi-mode qubit, based on inductance de-balancing. Suppose that the first and second multi-mode qubits are each initially encoded in the A mode. Furthermore, suppose that the first and second multi-mode qubits are each initially in the |0) state. Further still, suppose that the first and second multi-mode qubits are TCQs having SQUID loops instead of single Josephson junctions. That is, each of the first and second multi-mode qubits can have a first SQUID loop that is shunted by an end capacitor pad and a middle capacitor pad and a second SQUID loop that is shunted by the middle capacitor pad and a remaining end capacitor pad. In various aspects, inductances of the SQUID loops of the first multi-mode qubit can be balanced (e.g., equal to each other). Likewise, inductances of the SQUID loops of the second multi-mode qubit can be balanced (although not necessarily the same as the inductances of the SQUID loops of the first multi-mode qubit). In various instances, any suitable combination or sequence of quantum gates can be applied to the first multi-mode qubit, thereby transforming its initial |0) state into some resultant quantum state. Because the first and second multi-mode qubits are in the A mode, and because the dipole moment symmetry of the A mode does not match that of the cable, the first and second multi-mode qubits can be considered as being electrically isolated from each other, notwithstanding being coupled together by the cable. Thus, the second multi-mode qubit cannot “see” the resultant quantum state that is currently stored in the first multi-mode qubit. In various cases, the signal generator can apply a magnetic flux to the SQUID loops of the first multi-mode qubit, thereby causing their inductances to no longer be balanced. Due to such de-balancing, the dipole moment symmetry of the A mode of the first multi-mode qubit can change. Although the dipole moment symmetry of the A mode of the first multi-mode qubit will not necessarily become identical to that of the B mode, de-balancing can be considered causing the dipole moment symmetry of the A mode of the first multi-mode qubit to approach or otherwise become more like that of the B mode. In various aspects, the signal generator can likewise apply a magnetic flux to the SQUID loops of the second multi-mode qubit, thereby causing their inductances to no longer be balanced. At such point, both the first and second multi-mode qubits can, notwithstanding currently being encoded in the A mode, exhibit dipole moment symmetries that are at least somewhat like that of the B mode. Accordingly, the first and second multi-mode qubits can interact with each other. Specifically, the resultant quantum state that is stored within the first multi-mode qubit can, just as described above, travel or propagate with no or negligible loss across the cable toward the second multi-mode qubit, and the initial |0) state of the second multi-mode qubit can conversely counter-travel or counter-propagate across the cable toward the first multi-mode qubit. By de-balancing the SQUID loop inductances in this fashion, the resultant quantum state can thus be transferred from the first multi-mode qubit to the second multi-mode qubit without excessive fidelity loss.

As even another non-limiting example, the signal generator can perform or otherwise facilitate a remote quantum gate on the first multi-mode qubit and the second multi-mode qubit, based on cable driving. Suppose that the first and second multi-mode qubits are each initially encoded in the B mode. Because the first and second multi-mode qubits are each in the B mode, and because the dipole moment symmetry of the B mode matches that of the cable, the first and second multi-mode qubits can interact with each other. In various aspects, the signal generator can expose the cable, rather than the first and second multi-mode qubits, to a microwave pulse. In various instances, even though the first and second multi-mode qubits are not themselves exposed to the microwave pulse, whatever quantum states that they carry can nevertheless undergo a transformation or gate operation that depends upon the frequency of the microwave pulse. That is, the quantum states of the first and second multi-mode qubits can be controllably altered without directly or locally driving the first and second multi-mode qubits. By driving the cable in this fashion, a fully remote quantum gate can be performed on the first and second multi-mode qubits.

Various embodiments described herein can be employed to use hardware or software to solve problems that are highly technical in nature (e.g., to facilitate long-range quantum interactions via multi-mode qubits), that are not abstract, that are not mere laws of nature, that are not mere natural phenomena, and that cannot be performed as a set of mental acts by a human. Instead, various embodiments described herein include tangible electric circuit structures/architectures or methodologies pertaining to such tangible electric circuit structures/architectures that can be implemented so as to reduce fidelity losses that are usually associated with long-range quantum interactions. Various embodiments described herein can accomplish such loss reduction by leveraging or otherwise manipulating the distinct excitation modes of multi-mode qubits.

In particular, there can be two multi-mode qubits that are coupled by a long cable. The two multi-mode qubits can have at least two excitation modes, each having a respective dipole moment symmetry. Likewise, the cable can have its own dipole moment symmetry. In various aspects, the cable can be structured such that its dipole moment symmetry matches that of one of the excitation modes of the two multi-mode qubits. So, when the two multi-mode qubits are not encoded in that particular excitation mode, they cannot interact or communicate with each other. In contrast, when the two multi-mode qubits are encoded in that particular excitation mode, they can interact or communicate with each other nearly without loss.

In some embodiments, a quantum state can be transferred between the two multi-mode qubits via mode-switching. Specifically, the two multi-mode qubits can perform their normal or standard quantum processing while encoded in an excitation mode whose dipole moment symmetry does not match that of the cable. When it is desired for a quantum state transfer to occur, the two multi-mode qubits can be selectively switched to whichever excitation mode whose dipole moment symmetry matches that of the cable. In such case, if one of the two multi-mode qubits has a |0) state, then such mode-switching can be considered as transferring the quantum state of the other multi-mode qubit to that multi-mode qubit.

In other embodiments, a quantum state can be transferred between the two multi-mode qubits via inductance de-balancing. Specifically, the two multi-mode qubits can perform their normal or standard quantum processing while encoded in an excitation mode whose dipole moment symmetry does not match that of the cable. Additionally, each of the two multi-mode qubits can be a TCQ equipped with SQUID loops rather than single Josephson junctions, where inductances of those SQUID loops are initially balanced. When it is desired for a quantum state transfer to occur, the inductances of the SQUID loops of the two multi-mode qubits can be selectively de-balanced, thereby causing the dipole moment symmetries of the two multi-mode qubits to become more similar to that of the cable. In such case, if one of the two multi-mode qubits has a |0) state, then such de-balancing can be considered as transferring the quantum state of the other multi-mode qubit to that multi-mode qubit.

In even other embodiments, a fully remote quantum gate can be performed on the two multi-mode qubits via cable driving. Specifically, the two multi-mode qubits can be encoded in an excitation mode whose dipole moment symmetries match that of the cable. In various aspects, the cable (rather than the two multi-mode qubits) can be exposed to a microwave pulse. Since the dipole moment symmetries of the two multi-mode qubits can match that of the cable, the quantum states of the two multi-mode qubits can undergo a transformation in response to the cable being exposed to the microwave pulse, where the type or extent of such transformation can depend upon the frequency of the microwave pulse. Thus, the two multi-mode qubits can be considered as undergoing some quantum gate operation, notwithstanding the two multi-mode qubits not being directly exposed to or driven by any local microwave pulse.

By leveraging multi-mode qubits as described herein, quantum interactions can be achieved with high fidelity (e.g., experimentally verified at 98% or 99%) between qubits that are on the order of a meter apart (e.g., 50 centimeters apart, 100 centimeters apart, 150 centimeters apart).

Furthermore, various embodiments described herein can control tangible, hardware-based, or software-based devices based on the disclosed teachings. For example, embodiments described herein can include tangible qubits (e.g., superconducting qubits made up of Josephson junctions, capacitor pads, or inductive loops) that can be fabricated on tangible quantum substrates (e.g., silicon wafers).

It should be appreciated that the figures and the herein disclosure describe non-limiting examples of various embodiments. It should further be appreciated that the figures are not necessarily drawn to scale.

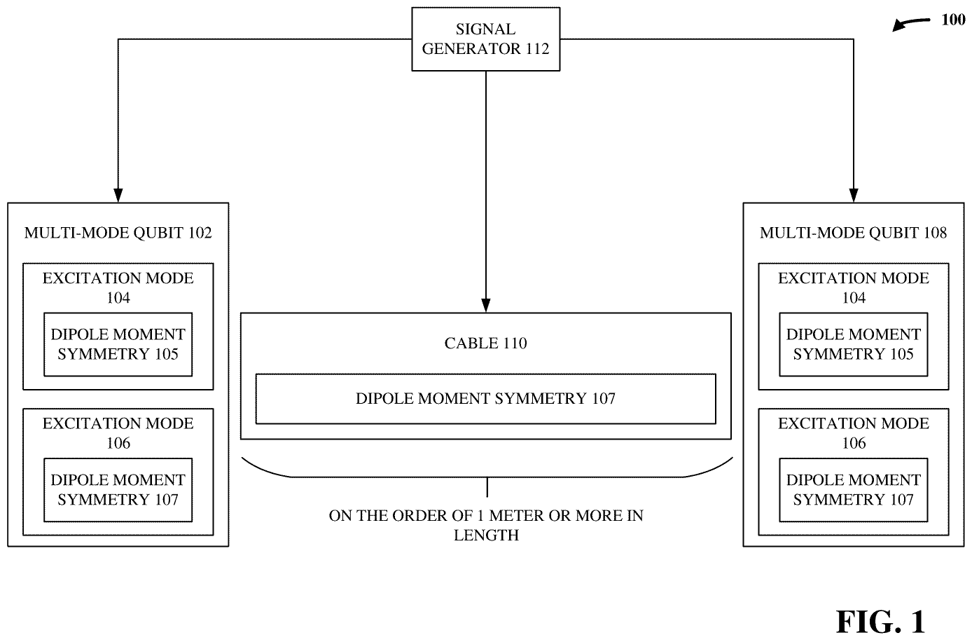

FIG. 1 illustrates a block diagram of an example, non-limiting system 100 that can facilitate long-range quantum interact via multi-mode qubits in accordance with one or more embodiments described herein.

In various embodiments, there can be a multi-mode qubit 102. In various aspects, the multi-mode qubit 102 can be any suitable type of qubit exhibiting any suitable type of construction or architecture. As a non-limiting example, the multi-mode qubit 102 can have, possess, or otherwise exhibit any suitable type of superconducting qubit construction or architecture, such as a TCQ. As another non-limiting example, the multi-mode qubit 102 can have, possess, or otherwise exhibit any suitable type of quantum dot construction or architecture. As even another non-limiting example, the multi-mode qubit 102 can have, possess, or otherwise exhibit any suitable type of spin qubit construction or architecture. As yet another non-limiting example, the multi-mode qubit 102 can have, possess, or otherwise exhibit any suitable type of trapped ion qubit construction or architecture. As still another non-limiting example, the multi-mode qubit 102 can have, possess, or otherwise exhibit any suitable type of photonic qubit construction or architecture. It should be understood or otherwise appreciated that the multi-mode qubit 102 can be manufactured on any suitable quantum computing substrate (e.g., silicon wafer) using any suitable microfabrication or nanofabrication techniques. Some non-limiting examples of such microfabrication or nanofabrication techniques can include chemical etching, chemical deposition, photolithography, or double-angle evaporation.

In any case, the multi-mode qubit 102 can be considered as being able to function or operate in at least two different modes of excitation. For ease of illustration and explanation, the herein disclosure will proceed as if the multi-mode qubit 102 has two modes of excitation. However, it should be understood or otherwise appreciated that the multi-mode qubit 102 can instead have more than two modes of excitation. As shown in FIG. 1, the two modes of excitation of the multi-mode qubit 102 can be referred to as an excitation mode 104 and an excitation mode 106. In various aspects, the excitation mode 104 and the excitation mode 106 can be considered as two separate or distinct physical or electromagnetic configurations that the multi-mode qubit 102 can use to represent quantum states. For instance, suppose that the quantum state of the multi-mode qubit 102 is

$$[ \begin{matrix}α \\ β\end{matrix} ] ,$$

which can be considered as the superposition α|0 [symbol] +β|1 [symbol] for any suitable real numbers α and β such that α²+β²=1. When the multi-mode qubit 102 is encoded within or otherwise operating or functioning according to the excitation mode 104, the multi-mode qubit 102 can exhibit some particular physical or electromagnetic behavior or activity (e.g., some particular Josephson junction energization) to represent

$$[ \begin{matrix}α \\ β\end{matrix} ] .$$

In contrast, when the multi-mode qubit 102 is encoded within or otherwise operating or functioning according to the excitation mode 106, the multi-mode qubit 102 can exhibit some different physical or electromagnetic behavior or activity to represent

$$[ \begin{matrix}α \\ β\end{matrix} ] .$$

Accordingly, the quantum state

$$( e . g . , [ \begin{matrix}α \\ β\end{matrix} ] )$$

can be considered as an information payload of interest that is carried by or stored in the multi-mode qubit 102, and the excitation mode 104 and the excitation mode 106 can be considered as distinct ways in which the multi-mode qubit 102 can physically or electromagnetically manifest or convey that information payload.

As a matter of nomenclature, when the multi-mode qubit 102 is encoded within or otherwise operating or functioning according to the excitation mode 104, the quantum state of the multi-mode qubit 102 can be referred to as “populating” or “occupying” the excitation mode 104. In like fashion, when the multi-mode qubit 102 is encoded within or otherwise operating or functioning according to the excitation mode 106, the quantum state of the multi-mode qubit 102 can be referred to as “populating” or “occupying” the excitation mode 106.

In various aspects, while the multi-mode qubit 102 is encoded within or otherwise operating or functioning according to the excitation mode 104, the multi-mode qubit 102 can physically exhibit a dipole moment symmetry 105. In various instances, the dipole moment symmetry 105 can be considered as referring to whatever physical profile, orientation, shape, or direction of flow that is exhibited by an electromagnetic field emitted by the multi-mode qubit 102 when the multi-mode qubit 102 is encoded in the excitation mode 104. Similarly, while the multi-mode qubit 102 is encoded within or otherwise operating or functioning according to the excitation mode 106, the multi-mode qubit 102 can physically exhibit a dipole moment symmetry 107 which can be different from or otherwise not identical to the dipole moment symmetry 105. Like above, the dipole moment symmetry 107 can be considered as referring to whatever physical profile, orientation, shape, or direction of flow that is exhibited by an electromagnetic field emitted by the multi-mode qubit 102 when the multi-mode qubit 102 is encoded in the excitation mode 106.

In various embodiments, there can be a multi-mode qubit 108. In various aspects, the multi-mode qubit 108 can exhibit any suitable type of qubit construction or architecture (e.g., the same or different construction or architecture as the multi-mode qubit 102). In various instances, the multi-mode qubit 108 can be manufactured on any suitable quantum computing substrate (e.g., the same or different silicon wafer as the multi-mode qubit 102) according to any suitable microfabrication or nanofabrication techniques (e.g., the same or different techniques as were used to manufacture the multi-mode qubit 102). Just like the multi-mode qubit 102, the multi-mode qubit 108 can be encoded within or otherwise operate or function according to the excitation mode 104 or the excitation mode 106. In various cases, the multi-mode qubit 108 can be physically located or positioned far away from the multi-mode qubit 102. As a non-limiting example, the multi-mode qubit 102 and the multi-mode qubit 108 can be located or positioned on the order of one meter away from each other. In other words, the physical linear distance separating the multi-mode qubit 102 from the multi-mode qubit 108 can be within one order of magnitude or any other suitable margin of one meter (e.g., can be as little as 10 centimeters, can be 50 centimeters, can be 100 centimeters, can be 150 centimeters, can be 500 centimeters, can be 1000 centimeters).

In various embodiments, there can be a cable 110. In various aspects, the cable 110 can be considered as a wire, channel, or transmission line having, possessing, or otherwise exhibiting any suitable superconducting construction or architecture. In various instances, as shown, the cable 110 can couple the multi-mode qubit 102 to the multi-mode qubit 108. Thus, the cable 110 can be lengthy enough so as to physically span or traverse the distance that separates the multi-mode qubit 102 from the multi-mode qubit 108.

In various cases, the cable 110 can be coupled to the multi-mode qubit 102 in any suitable fashion. As a non-limiting example, the cable 110 can be capacitively coupled to the multi-mode qubit 102. As another non-limiting example, the cable 110 can be inductively coupled to the multi-mode qubit 102. As even another non-limiting example, the cable 110 can be galvanically coupled to the multi-mode qubit 102. Likewise, the cable 110 can be coupled to the multi-mode qubit 108 in any suitable fashion (e.g., in capacitive, inductive, or galvanic fashion).

It should be understood or otherwise appreciated that the cable 110 can be manufactured using any suitable microfabrication or nanofabrication techniques. In some instances, the cable 110 can be stationarily affixed onto whatever quantum computing substrates hold the multi-mode qubit 102 and the multi-mode qubit 108 (or possibly onto other, intermediary quantum computing substrates that are located or interposed between the multi-mode qubit 102 and the multi-mode qubit 108). In other instances, however, the cable 110 can instead be movable or otherwise not affixed to any quantum computing substrate.

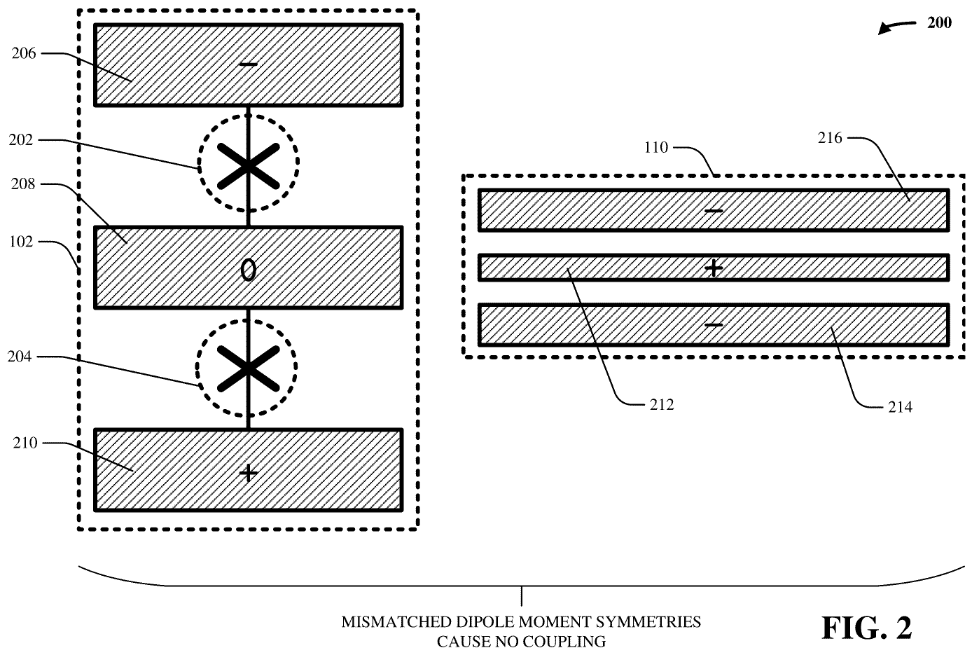

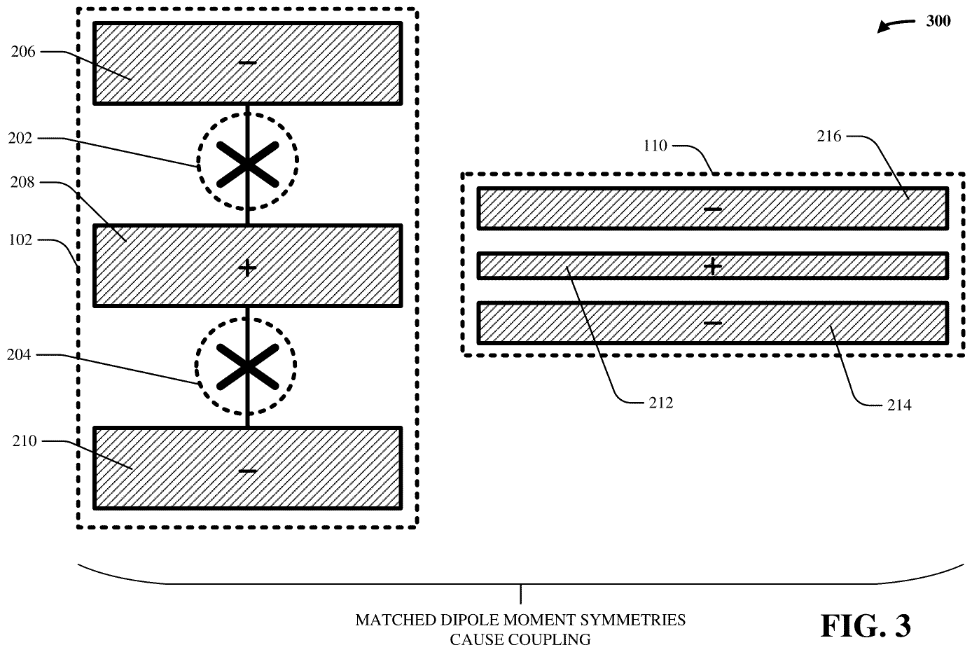

In any case, the cable 110 can be considered as exhibiting its own dipole moment symmetry. Indeed, because the cable 110 can be electrically conductive, it can emit an electromagnetic field, and the physical profile, orientation, shape, or direction of flow that is exhibited by that electromagnetic field can be considered as the dipole moment symmetry of the cable 110. In various aspects, and without loss of generality, the cable 110 can be physically configured, structured, or otherwise fabricated so that its dipole moment symmetry matches or is the same as that of the excitation mode 106. In other words, the cable 110 can constructed so as to have, possess, or otherwise exhibit the dipole moment symmetry 107. Various non-limiting aspects are described with respect to FIGS. 2-3.

FIGS. 2-3 illustrate example, non-limiting structural diagrams 200 and 300 showing how a dipole moment symmetry of the multi-mode qubit 102 can match or not match that of the cable 110 in accordance with one or more embodiments described herein.

First, consider FIG. 2. In various embodiments, the multi-mode qubit 102 can be made up of a Josephson junction 202, a Josephson junction 204, a capacitor pad 206, a capacitor pad 208, and a capacitor pad 210. In various aspects, as shown, the Josephson junction 202 can be coupled to the capacitor pad 206 and to the capacitor pad 208, such that the capacitor pad 206, the Josephson junction 202, and the capacitor pad 208 can be considered as all being in series with each other. Accordingly, in various instances, the capacitor pad 206 and the capacitor pad 208 can collectively be considered as forming a capacitance that shunts the Josephson junction 202.

Similarly, in various cases, as shown, the Josephson junction 204 can be coupled to the capacitor pad 208 and to the capacitor pad 210, such that the capacitor pad 208, the Josephson junction 204, and the capacitor pad 210 can be considered as all being in series with each other. Thus, in various aspects, the capacitor pad 208 and the capacitor pad 210 can collectively be considered as forming a capacitance that shunts the Josephson junction 204.

Moreover, in various instances, as shown, the capacitor pad 206, the Josephson junction 202, the capacitor pad 208, the Josephson junction 204, and the capacitor pad 210 can all be considered as being in series with each other. Accordingly, in various cases, the capacitor pad 206 and the capacitor pad 210 can be considered as collectively forming a capacitance that shunts both the Josephson junction 202 and the Josephson junction 204.

Accordingly, in various aspects, the multi-mode qubit 102 can be considered as a two-junction transmon or TCQ formed by two serially-coupled single-junction transmons. In particular, the capacitor pad 206, the Josephson junction 202, and the capacitor pad 208 can collectively be considered as forming a first single-junction transmon. Likewise, the capacitor pad 208, the Josephson junction 204, and the capacitor pad 210 can collectively be considered as forming a second single-junction transmon that is in series with the first single-junction transmon. As can be seen, the first single-junction transmon and the second single-junction transmon can be considered as sharing the capacitor pad 208. Accordingly, in various instances, the capacitor pad 208 can be referred to as a middle pad of the multi-mode qubit 102, whereas the capacitor pad 206 and the capacitor pad 210 can be referred to as end pads of the multi-mode qubit 102.

In various cases, the capacitor pad 206, the Josephson junction 202, the capacitor pad 208, the Josephson junction 204, or the capacitor pad 210 can be fabricated or manufactured via any suitable microfabrication or nanofabrication techniques (e.g., photolithography, deposition, etching, double-angle evaporation) on any suitable quantum substrate. In various instances, the capacitor pad 206, the Josephson junction 202, the capacitor pad 208, the Josephson junction 204, or the capacitor pad 210 can be fabricated or manufactured from any suitable superconducting materials or combinations of superconducting materials as desired.

Although FIG. 2 depicts the Josephson junction 202 and the Josephson junction 204 as being identical to each other (e.g., as being identically-sized or as being identically-structured), this is a mere non-limiting example for ease of illustration. In various aspects, the Josephson junction 202 and the Josephson junction 204 can have the same or different sizes, shapes, spatial dimensions, or material compositions as each other.

Similarly, although FIG. 2 depicts the capacitor pad 206, the capacitor pad 208, and the capacitor pad 210 as being identical to each other (e.g., as being identically-sized or identically-structured), this is a mere non-limiting example for ease of illustration. Indeed, in various instances, the capacitor pad 206, the capacitor pad 208, and the capacitor pad 210 can have the same or different sizes, shapes, spatial dimensions, or material compositions as each other.

In various aspects, the cable 110 can be made up of a conductor 212, a conductor 214, and a conductor 216. As shown, the conductor 212 can be physically positioned, located, or otherwise sandwiched in between the conductor 214 and the conductor 216. Although not explicitly shown in FIG. 2, it should be understood or otherwise appreciated that any suitable insulator or dielectric layer can be physically located in between the conductor 212 and the conductor 214, so as to prevent the conductor 212 from shorting to the conductor 214. Likewise, although not explicitly shown in FIG. 2, it should be understood or otherwise appreciated that any suitable insulator or dielectric layer can be physically located in between the conductor 212 and the conductor 216, so as to prevent the conductor 212 from shorting to the conductor 216. In various instances, the conductor 212, the conductor 214, and the conductor 216 can be fabricated or manufactured via any suitable microfabrication or nanofabrication techniques on any suitable quantum substrates from any suitable superconducting materials or combinations of superconducting materials as desired. It should be understood or otherwise appreciated that the conductor 212, the conductor 214, and the conductor 216 can have the same or different sizes, shapes, spatial dimensions, or material compositions as each other.

In some aspects, the cable 110 can be a coplanar waveguide. In such situations, the conductor 212 can be considered as a central wire or central transmission line of the coplanar waveguide, and both the conductor 214 and the conductor 216 can be considered as ground planes of the coplanar waveguide which flank the central wire or central transmission line.

In other aspects, the cable 110 can be a coaxial channel. In such situations, the conductor 212 can be considered as a conductive core of the coaxial channel, and both the conductor 214 and the conductor 216 can be collectively considered as a conductive shield or conductive shell of the coaxial channel that sheathes the conductive core.

In the non-limiting example of FIG. 2, the cable 110 can be considered as being capacitively coupled to the multi-mode qubit 102. In other words, the cable 110 and the multi-mode qubit 102 can be not directly touching or abutting each other, but can nevertheless be within any suitable physical proximity of each other, such that a capacitive electric interaction can occur between the capacitor pad 208 (or any other capacitor pad of the multi-mode qubit 102) and any or all of the conductors of the cable 110.

In any case, both the multi-mode qubit 102 and the cable 110 can exhibit their own dipole moment symmetries. In some instances, those dipole moment symmetries can match each other. In other instances, those dipole moment symmetries can be mismatched with each other.

FIG. 2 illustrates a non-limiting example in which the dipole moment symmetries of the multi-mode qubit 102 and the cable 110 are mismatched.

Indeed, in the non-limiting example of FIG. 2, the multi-mode qubit 102 can be considered as exhibiting the dipole moment symmetry 105. Specifically, the capacitor pad 208 can be neutrally charged (as indicated by the bolded “0” overlaid on the capacitor pad 208), the capacitor pad 206 can be negatively charged (as indicated by the bolded “−” overlaid on the capacitor pad 206, and the capacitor pad 210 can be positively charged (as indicated by the bolded “+” overlaid on the capacitor pad 210. Such charging profile can cause electromagnetic field lines to flow from the capacitor pad 210, around the capacitor pad 208, and toward the capacitor pad 206. In the non-limiting example of FIG. 2, such bottom-to-top electromagnetic field orientation can be considered as the dipole moment symmetry 105. Note that the multi-mode qubit 102 can exhibit the dipole moment symmetry 105 when the multi-mode qubit 102 is encoded within or otherwise operating or functioning according to the excitation mode 104.

In contrast, the cable 110 in the non-limiting example of FIG. 2 can exhibit the dipole moment symmetry 107. Specifically, the conductor 212 can be positively charged (as indicated by the bolded “+” overlaid on the conductor 212), the conductor 214 can be negatively charged (as indicated by the bolded “−” overlaid on the conductor 214), and the conductor 216 can also be negatively charged (as indicated by the bolded “−” overlaid on the conductor 216). Such charging profile can cause electromagnetic field lines to flow from the conductor 212 toward the conductor 214 and also toward the conductor 216. In the non-limiting example of FIG. 2, such interior-to-exterior electromagnetic field orientation can be considered as the dipole moment symmetry 107.

In any case, because the dipole moment symmetry (e.g., the electromagnetic field orientation) of the multi-mode qubit 102 can be mismatched with or otherwise different from that of the cable 110, there can be no (or at most negligible) electromagnetic coupling or interaction between the cable 110 and the multi-mode qubit 102. In other words, when the dipole moment symmetries of the multi-mode qubit 102 and the cable 110 are mismatched, whatever quantum state

$$( e . g . , [ \begin{matrix}α \\ β\end{matrix} ] )$$

that is stored in or otherwise represented by the multi-mode qubit 102 cannot meaningfully transmit across, propagate across, or otherwise be carried by the cable 110.

Next, consider FIG. 3. In contrast to FIG. 2, FIG. 3 illustrates a non-limiting example in which the dipole moment symmetries of the multi-mode qubit 102 and the cable 110 are matched.

As shown, the cable 110 can still exhibit the dipole moment symmetry 107, in which the conductor 212 can be positively charged, and in which both the conductor 214 and the conductor 216 can be negatively charged. However, as also shown, the multi-mode qubit 102 can likewise exhibit the dipole moment symmetry 107. Specifically, the capacitor pad 208 can be positively charged (as indicated by the bolded “+” overlaid on the capacitor pad 208), the capacitor pad 206 can be negatively charged (as indicated by the bolded “−” overlaid on the capacitor pad 206, and the capacitor pad 210 can also be negatively charged (as indicated by the bolded “−” overlaid on the capacitor pad 210. Such charging profile can cause electromagnetic field lines to flow from the capacitor pad 208 toward the capacitor pad 210 and also toward the capacitor pad 206. As mentioned above, such interior-to-exterior electromagnetic field orientation can be considered as the dipole moment symmetry 107. Note that the multi-mode qubit 102 can exhibit the dipole moment symmetry 107 when the multi-mode qubit 102 is encoded within or otherwise operating or functioning according to the excitation mode 106.

In any case, because the dipole moment symmetry (e.g., the electromagnetic field orientation) of the multi-mode qubit 102 can be matched with or otherwise the same as that of the cable 110, there can be lossless (or at most negligibly lossy) electromagnetic coupling or interaction between the cable 110 and the multi-mode qubit 102. In other words, when the dipole moment symmetries of the multi-mode qubit 102 and the cable 110 are matched, whatever quantum state

$$( e . g . , [ \begin{matrix}α \\ β\end{matrix} ] )$$

that is stored in or otherwise represented by the multi-mode qubit 102 can transmit across, propagate across, or otherwise be carried by the cable 110 without significant levels or amounts of degradation.

Although FIGS. 2-3 do not explicitly show the multi-mode qubit 108, it should be understood or otherwise appreciated that the teachings regarding matched or mismatched dipole moment symmetries conveyed by FIGS. 2-3 are equally applicable to the multi-mode qubit 108.

Referring back to FIG. 1, there can be a signal generator 112. In various aspects, the signal generator 112 can be any suitable device that can controllably or selectively generate waveforms. As a non-limiting example, the signal generator 112 can be any suitable voltage-controlled oscillator. As another non-limiting example, the signal generator 112 can be any suitable current-controlled oscillator. As yet another non-limiting example, the signal generator 112 can be any suitable numerically-controlled oscillator. As still another non-limiting example, the signal generator 112 can be any suitable direct digital synthesizer (DDS). As even another non-limiting example, the signal generator 112 can be any suitable frequency synthesizer. As another non-limiting example, the signal generator 112 can be any suitable arbitrary waveform generator (AWG). In any case, the signal generator 112 can be able to electronically create or electronically generate any suitable signals, waveforms, or pulses that have any suitable electromagnetic characteristics, properties, or attributes. In other words, the signal generator 112 can be able to create or generate any suitable transient or time-varying signals, waveforms, or pulses having controllable or selectable amplitudes, having controllable or selectable frequencies, or having controllable or selectable phases.

Because quantum properties can be considered as being best exhibited at cryogenic temperatures, it can be the case that the multi-mode qubit 102, the cable 110, and the multi-mode qubit 108 are physically located, physically positioned, or otherwise physically present within any suitable cryogenic chamber. In various aspects, the cryogenic chamber can exhibit any suitable construction, design, or architecture that is capable of reducing the temperatures of the multi-mode qubit 102, the cable 110, or the multi-mode qubit 108 to cryogenic levels (e.g., to below 10 Kelvin, to below 5 Kelvin, or to the order of milli-Kelvin). As a non-limiting example, the cryogenic chamber can be any suitable type of cryostat, such as a continuous-flow cryostat or a Gifford-McMahon cryostat. As another non-limiting example, the cryogenic chamber can be any suitable type of dilution refrigerator. As even another non-limiting example, the cryogenic chamber can be any suitable type of cryogenic vacuum system.

In some instances, the signal generator 112 can be physically located, physically placed, or otherwise physically present inside of the cryogenic chamber. After all, although the signal generator 112 can consume a non-zero amount of electric power in order to create or generate waveforms, it should be understood or otherwise appreciated that there are various waveform generator designs that can nevertheless be implemented at cryogenic temperatures without exposing nearby qubits to significant risks of destabilization. However, this is a mere non-limiting example. In other instances, the signal generator 112 can instead be physically located, physically placed, or otherwise physically present outside of the cryogenic chamber. As a non-limiting example, the signal generator 112 can be located in a room-temperature environment. As another non-limiting example, there can be any suitable number of intermediate temperature-controlled chambers that are maintained at respective temperatures that are below room-temperature but above cryogenic temperatures, hence the term “intermediate”. In such situations, the signal generator 112 can be physically located, physically placed, or otherwise physically present within any of those other intermediate temperature-controlled chambers.

In any case, the signal generator 112 can be electrically coupled via any suitable wires, channels, or transmission lines to each of the multi-mode qubit 102, the cable 110, and the multi-mode qubit 108. As a non-limiting example, an output port of the signal generator 112 can be capacitively, inductively, or galvanically coupled by any suitable first quantum computing wire or wires to the multi-mode qubit 102. By controllably emitting microwave pulses into or along such first quantum computing wire or wires, the signal generator 112 can controllably drive the multi-mode qubit 102, so as to selectively switch the multi-mode qubit 102 from the excitation mode 104 to the excitation mode 106 or vice versa, or so as to selectively transform whatever quantum state is stored in or represented by the multi-mode qubit 102. As another non-limiting example, an output port of the signal generator 112 can be capacitively, inductively, or galvanically coupled by any suitable second quantum computing wire or wires to the multi-mode qubit 108. By controllably emitting microwave pulses into or along such second quantum computing wire or wires, the signal generator 112 can controllably drive the multi-mode qubit 108, so as to selectively switch the multi-mode qubit 108 from the excitation mode 104 to the excitation mode 106 or vice versa, or so as to selectively transform whatever quantum state is stored in or represented by the multi-mode qubit 108. As even another non-limiting example, an output port of the signal generator 112 can be capacitively, inductively, or galvanically coupled by any suitable third quantum computing wire or wires to the cable 110. By controllably emitting microwave pulses into or along such third quantum computing wire or wires, the signal generator 112 can controllably drive the cable 110.

Although not explicitly shown in FIG. 1, it should be understood or otherwise appreciated that any other suitable hardware or software (e.g., real-time controllers implemented in field programmable gate arrays) can be used or otherwise implemented in addition to the multi-mode qubit 102, the multi-mode qubit 108, the cable 110, and the signal generator 112, such as additional hardware or software for initializing quantum states of the multi-mode qubit 102 or the multi-mode qubit 108 or for performing any suitable quantum operations (e.g., quantum gates, qubit measurements, qubit idling) on the multi-mode qubit 102 or the multi-mode qubit 108.

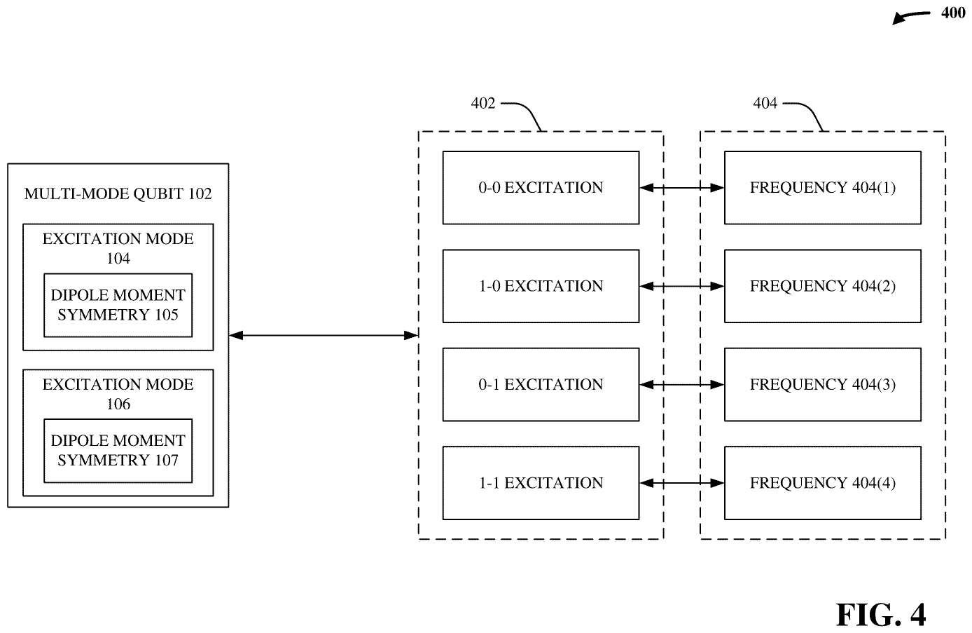

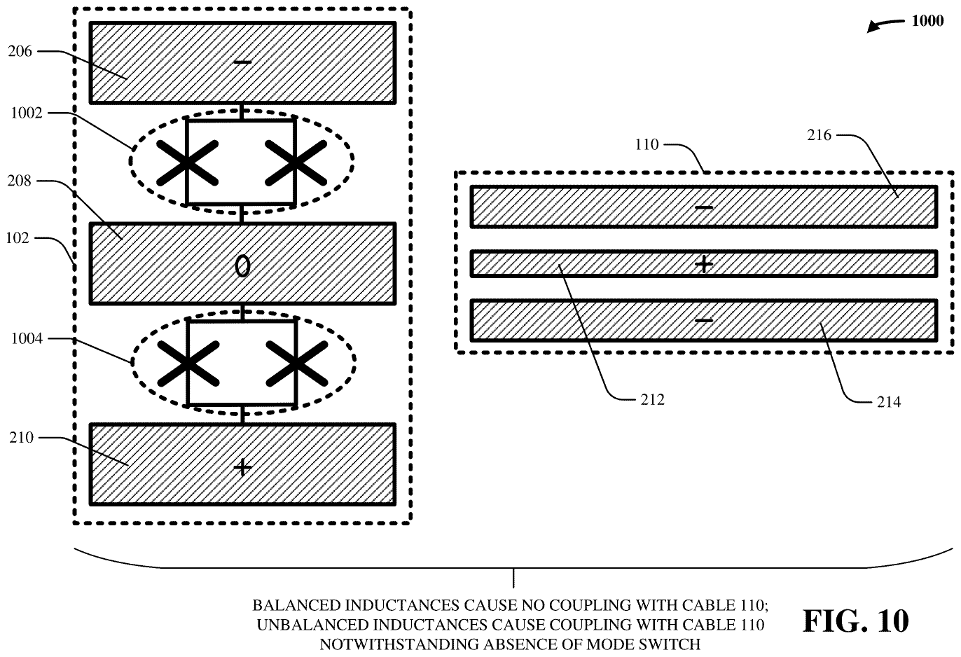

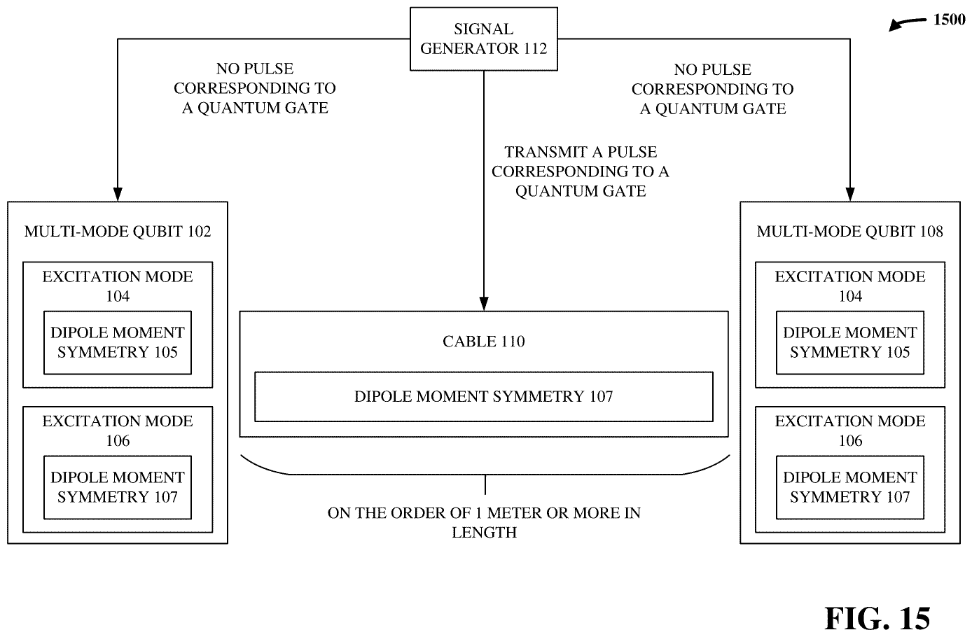

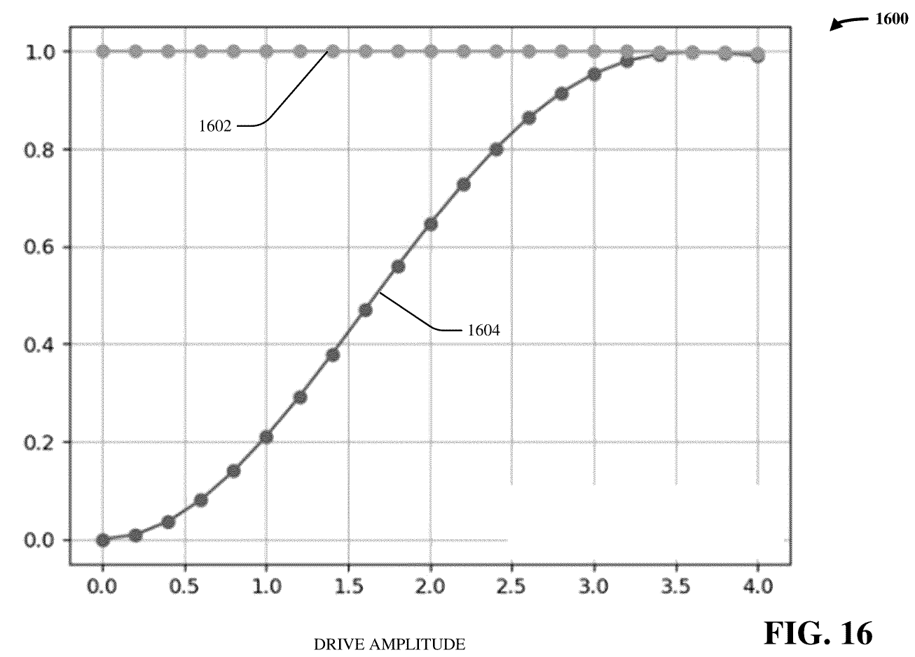

In any case, the signal generator 112 can facilitate a high-fidelity quantum interaction between the multi-mode qubit 102 and the multi-mode qubit 108, notwithstanding the multi-mode qubit 102 and the multi-mode qubit 108 being located or positioned on the order of one meter or more apart from each other. As described herein, the signal generator 112 can facilitate such high-fidelity quantum interaction by leveraging the fact that the dipole moment symmetry of the cable 110 matches that of the excitation mode 106 but not that of the excitation mode 104. Particularly, in some embodiments, the signal generator 112 can facilitate a quantum state transfer between the multi-mode qubit 102 and the multi-mode qubit 108 via mode-switching, as described with respect to FIGS. 4-9. In other embodiments, the signal generator 112 can facilitate a quantum state transfer between the multi-mode qubit 102 and the multi-mode qubit 108 via inductance de-balancing, as described with respect to FIGS. 10-14. In even other embodiments, the signal generator 112 can perform a fully remote quantum gate on the multi-mode qubit 102 and the multi-mode qubit 108 via cable driving, as described with respect to FIGS. 15-16.

FIGS. 4-7 illustrate example, non-limiting block diagrams 400, 500, 600, and 700 showing how mode-switching can be implemented to facilitate a state transfer between two multi-mode qubits in accordance with one or more embodiments described herein.

First, consider FIG. 4. In various embodiments, the multi-mode qubit 102 can correspond to a plurality of excitations 402. In various aspects, each of the plurality of excitations 402 can be considered as a respective permutation or combination in which or by which the multi-mode qubit 102 can utilize the excitation mode 104 or the excitation mode 106 to store or represent quantum information. In various instances, the plurality of excitations 402 can include a 0-0 excitation, a 1-0 excitation, a 0-1 excitation, or a 1-1 excitation.

In various cases, when the multi-mode qubit 102 is in the 0-0 excitation, the multi-mode qubit 102 can be considered as not carrying any quantum state at all. In other words, a quantum state can be considered as populating or occupying neither the excitation mode 104 of the multi-mode qubit 102 nor the excitation mode 106 of the multi-mode qubit 102, such that the multi-mode qubit 102 can be considered as being blank or inactive. Thus, when in the 0-0 excitation, the multi-mode qubit 102 can exhibit no dipole moment at all.

In various aspects, when the multi-mode qubit 102 is in the 1-0 excitation, the multi-mode qubit 102 can be considered as carrying quantum state information in the excitation mode 104 but not in the excitation mode 106. In other words, a quantum state can be considered as populating or occupying the excitation mode 104 of the multi-mode qubit 102 but not populating or occupying the excitation mode 106 of the multi-mode qubit 102, such that the multi-mode qubit 102 can be considered as being encoded in or otherwise operating or functioning according to the excitation mode 104. Thus, when in the 1-0 excitation, the multi-mode qubit 102 can exhibit the dipole moment symmetry 105.

In various instances, when the multi-mode qubit 102 is in the 0-1 excitation, the multi-mode qubit 102 can be considered as carrying quantum state information in the excitation mode 106 but not in the excitation mode 104. In other words, a quantum state can be considered as populating or occupying the excitation mode 106 of the multi-mode qubit 102 but not populating or occupying the excitation mode 104 of the multi-mode qubit 102, such that the multi-mode qubit 102 can be considered as being encoded in or otherwise operating or functioning according to the excitation mode 106. Thus, when in the 0-1 excitation, the multi-mode qubit 102 can exhibit the dipole moment symmetry 107.

In various cases, when the multi-mode qubit 102 is in the 1-1 excitation, the multi-mode qubit 102 can be considered as carrying quantum state information in both the excitation mode 104 and the excitation mode 106. In other words, a quantum state can be considered as populating or occupying the excitation mode 104 of the multi-mode qubit 102 and as also populating or occupying the excitation mode 106 of the multi-mode qubit 102, such that the multi-mode qubit 102 can be considered as being encoded in or otherwise operating or functioning according to both the excitation mode 104 and the excitation mode 106. It should understood or otherwise appreciated that the 1-1 excitation can be considered as a higher-order, and thus more complex, excitation of the multi-mode qubit 102. Thus, when in the 1-1 excitation, the multi-mode qubit 102 can exhibit a dipole moment whose symmetry is some combination of the dipole moment symmetry 105 and the dipole moment symmetry 107.

In various aspects, the plurality of excitations 402 can respectively correspond to a plurality of frequencies 404. In various instances, each of the plurality of frequencies 404 can be a microwave pulse frequency (e.g., measured in Hertz (Hz)) which can cause the multi-mode qubit 102 to enter a respective one of the plurality of excitations 402. As a non-limiting example, the 0-0 excitation can correspond to a frequency 404(1). This means that the multi-mode qubit 102 can enter the 0-0 excitation (e.g., can become inactive) when it is exposed to or driven by a microwave pulse whose frequency is equal to (or otherwise within any suitable margin of) the frequency 404(1). As another non-limiting example, the 1-0 excitation can correspond to a frequency 404(2). This means that the multi-mode qubit 102 can enter the 1-0 excitation (e.g., can become encoded in the excitation mode 104) when it is exposed to or driven by a microwave pulse whose frequency is equal to (or otherwise within any suitable margin of) the frequency 404(2). As even another non-limiting example, the 0-1 excitation can correspond to a frequency 404(3). This means that the multi-mode qubit 102 can enter the 0-1 excitation (e.g., can become encoded in the excitation mode 106) when it is exposed to or driven by a microwave pulse whose frequency is equal to (or otherwise within any suitable margin of) the frequency 404(3). As yet another non-limiting example, the 1-1 excitation can correspond to a frequency 404(4). This means that the multi-mode qubit 102 can enter the 1-1 excitation (e.g., can become encoded in both the excitation mode 104 and the excitation mode 106) when it is exposed to or driven by a microwave pulse whose frequency is equal to (or otherwise within any suitable margin of) the frequency 404(4).

Although not explicitly shown in FIG. 4, it should be understood or otherwise appreciated that the multi-mode qubit 108 can likewise correspond to the plurality of excitations 402. In some cases, the frequencies that cause the multi-mode qubit 108 to enter respective ones of the plurality of excitations 402 can be equal to the plurality of frequencies 404. In other cases, however, the frequencies that cause the multi-mode qubit 108 to enter respective ones of the plurality of excitations 402 can be unequal to or otherwise different from the plurality of frequencies 404.

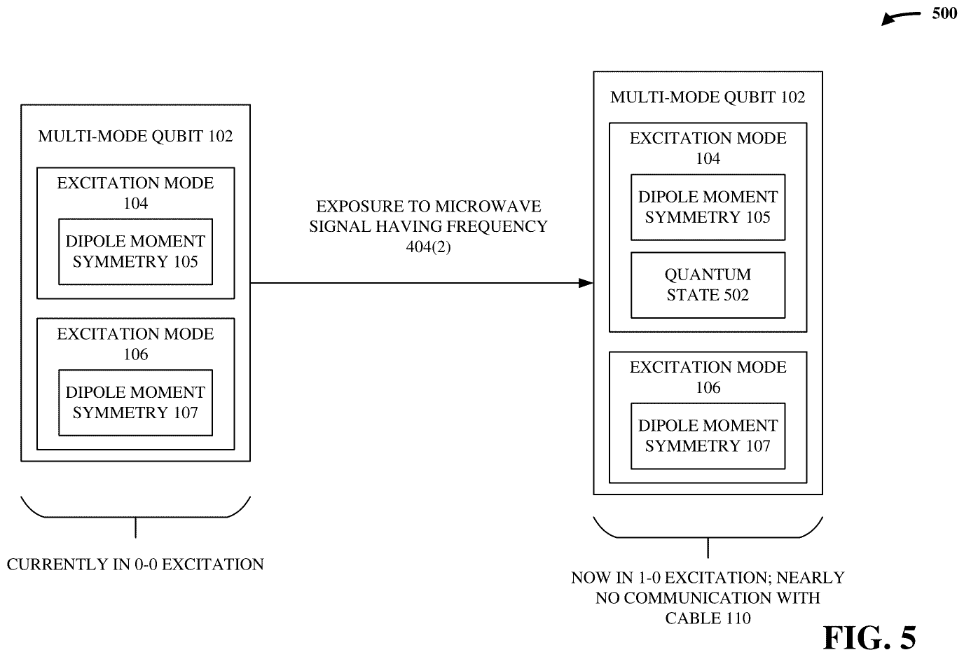

Now, consider FIG. 5. In various embodiments, the multi-mode qubit 102 can initially begin in the 0-0 excitation. That is, the multi-mode qubit 102 can initially be inactive and thus have no quantum information at all. In various aspects, the signal generator 112 can drive the multi-mode qubit 102 with a microwave pulse having the frequency 404(2). Exposure to such microwave pulse can cause the multi-mode qubit 102 to enter the 1-0 excitation. That is, such exposure can cause the multi-mode qubit 102 to now be encoded in the excitation mode 104, such that a quantum state 502 can be considered as populating or occupying the excitation mode 104. Although not explicitly shown in FIG. 5, it should be understood or otherwise appreciated that, after exposure to the microwave pulse having the frequency 404(2), the multi-mode qubit 102 can be exposed to or driven by any other suitable microwave pulses whose frequencies are controllably tuned or selected to transform or alter the quantum state 502 in any desired fashions. In other words, such other microwave pulses can be considered as locally performing any desired quantum gates on the multi-mode qubit 102 while the multi-mode qubit 102 is encoded in the excitation mode 104. In any case, because the multi-mode qubit 102 can now be in the 1-0 excitation, it can exhibit the dipole moment symmetry 105. Thus, there can be a mismatch between the dipole moment symmetry of the multi-mode qubit 102 and that of the cable 110. So, there can accordingly be no (or nearly no) communication or interaction between the multi-mode qubit 102 and the cable 110.

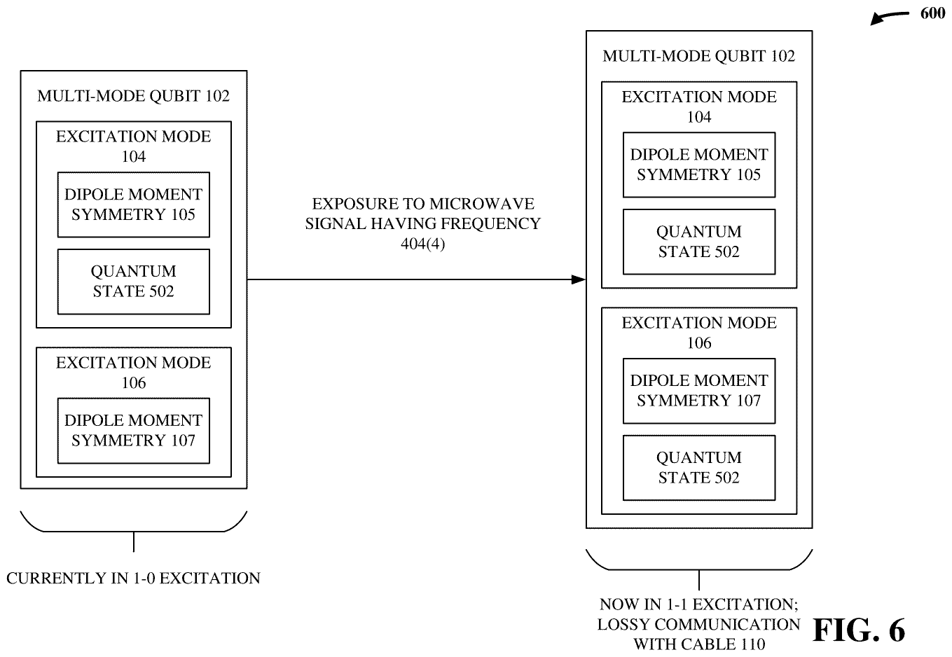

Next, consider FIG. 6. As explained above, the multi-mode qubit 102 can currently or presently be in the 1-0 excitation. In various aspects, the signal generator 112 can drive the multi-mode qubit 102 with a microwave pulse having the frequency 404(4). Exposure to such microwave pulse can cause the multi-mode qubit 102 to enter the 1-1 excitation. That is, such exposure can cause the multi-mode qubit 102 to now be encoded in both the excitation mode 104 and the excitation mode 106, such that the quantum state 502 can be considered as populating or occupying the excitation mode 104 and as also populating or occupying the excitation mode 106. In some instances, this can be considered as transferring the quantum state 502 from the excitation mode 104 to the excitation mode 106. In any case, because the multi-mode qubit 102 can now be in the 1-1 excitation, it can exhibit some combination of the dipole moment symmetry 105 and the dipole moment symmetry 107. If this configuration were to be maintained for a substantial length of time, it could yield lossy communication or interaction between the multi-mode qubit 102 and the cable 110.

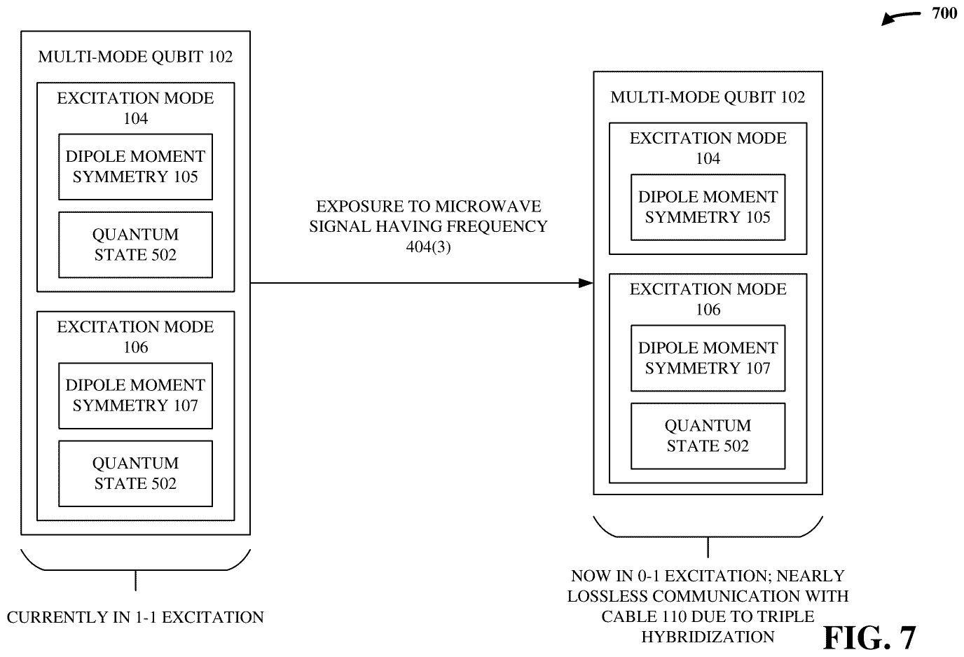

Now, consider FIG. 7. As explained above, the multi-mode qubit 102 can currently or presently be in the 1-1 excitation. In various aspects, the signal generator 112 can drive the multi-mode qubit 102 with a microwave pulse having the frequency 404(3). Exposure to such microwave pulse can cause the multi-mode qubit 102 to enter the 0-1 excitation. That is, such exposure can cause the multi-mode qubit 102 to now be encoded in the excitation mode 106 and not the excitation mode 104, such that the quantum state 502 can be considered as populating or occupying the excitation mode 106 and as not populating or occupying the excitation mode 104. In some instances, this can be considered as deleting the quantum state 502 from the excitation mode 104. In any case, because the multi-mode qubit 102 can now be in the 0-1 excitation, it can exhibit the dipole moment symmetry 107. So, there can be a match between the dipole moment symmetry of the multi-mode qubit 102 and that of the cable 110. Accordingly, there can be a reduced-loss communication or interaction between the multi-mode qubit 102 and the cable 110.

It should be understood or otherwise appreciated that the signal generator 112 can cause the multi-mode qubit 108 to transition from the 0-0 excitation to the 0-1 excitation as described with respect to FIGS. 5-7. Now, suppose that the multi-mode qubit 108 is in the 0-1 excitation at the same time that the multi-mode qubit 102 is in the 0-1 excitation. In such situation, the dipole moment symmetries of the multi-mode qubit 102, of the cable 110, and of the multi-mode qubit 108 can all match each other. This can be considered as forming a triple hybridization in which the multi-mode qubit 102 and the multi-mode qubit 108 can communicate or interact with no (or nearly no) loss contributed by the cable 110 (e.g., similar to how, when three masses are serially coupled by springs, their overall oscillatory motion is dominated by the end masses and nearly unaffected by the middle mass).

Now, suppose that the quantum state (which is currently or presently populating or occupying the excitation mode 106) of the multi-mode qubit 108 is |0). In such case, the triple hybridization mentioned above can cause the quantum state 502 to transmit or propagate across the cable 110 toward the multi-mode qubit 108. Upon reaching the multi-mode qubit 108, the quantum state 502 can be considered as combining with whatever current or present quantum state is stored in or represented by the multi-mode qubit 108. Since that current or present quantum state is |0), such combination can cause the multi-mode qubit 108 to now store or represent (in the excitation mode 106) the quantum state 502 (e.g., adding the quantum state 502 to |0) can yield the quantum state 502). Simultaneously, the triple hybridization mentioned above can cause the |0) state stored or represented in the multi-mode qubit 108 to counter-transmit or counter-propagate across the cable 110 toward the multi-mode qubit 102. Upon reaching the multi-mode qubit 102, that |0) state can be considered as combining with whatever current or present quantum state is stored in or represented by the multi-mode qubit 102. Since that current or present quantum state is the quantum state 502, such combination can cause the multi-mode qubit 102 to still store or represent (in the excitation mode 106) the quantum state 502 (e.g., adding |0) to the quantum state 502 can yield the quantum state 502).

At this point, the quantum state 502 can be considered as populating or occupying both the excitation mode 106 of the multi-mode qubit 102 and the excitation mode 106 of the multi-mode qubit 108. Accordingly, by switching or otherwise manipulating the excitation mode 104 and the excitation mode 106 as described with respect to FIGS. 5-7, the signal generator 112 can be considered as transferring the quantum state 502 from the multi-mode qubit 102 to the multi-mode qubit 108 with no (or nearly no) loss, notwithstanding that the multi-mode qubit 102 and the multi-mode qubit 108 are on the order of one meter apart.

After the quantum state 502 populates the excitation mode 106 of the multi-mode qubit 108, the signal generator 112 can drive the multi-mode qubit 108 with any suitable microwave pulses so that the quantum state 502 instead populates or occupies the excitation mode 104 of the multi-mode qubit 108 (e.g., causing the multi-mode qubit 108 to go from the 0-1 excitation to the 1-1 excitation and then to the 1-0 excitation). At such point, any desired quantum gates or transformations can be locally applied to the multi-mode qubit 108.

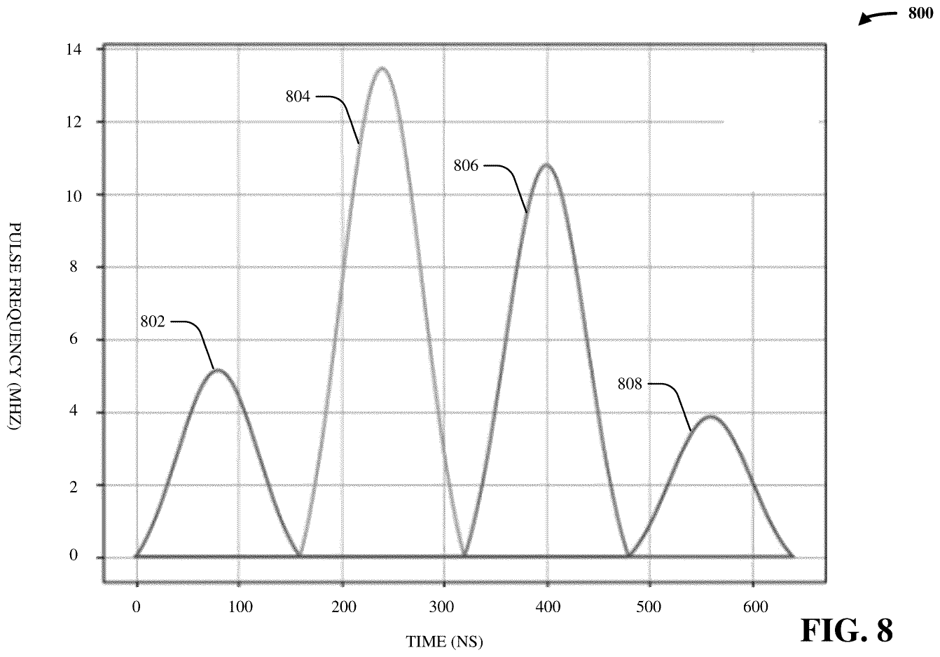

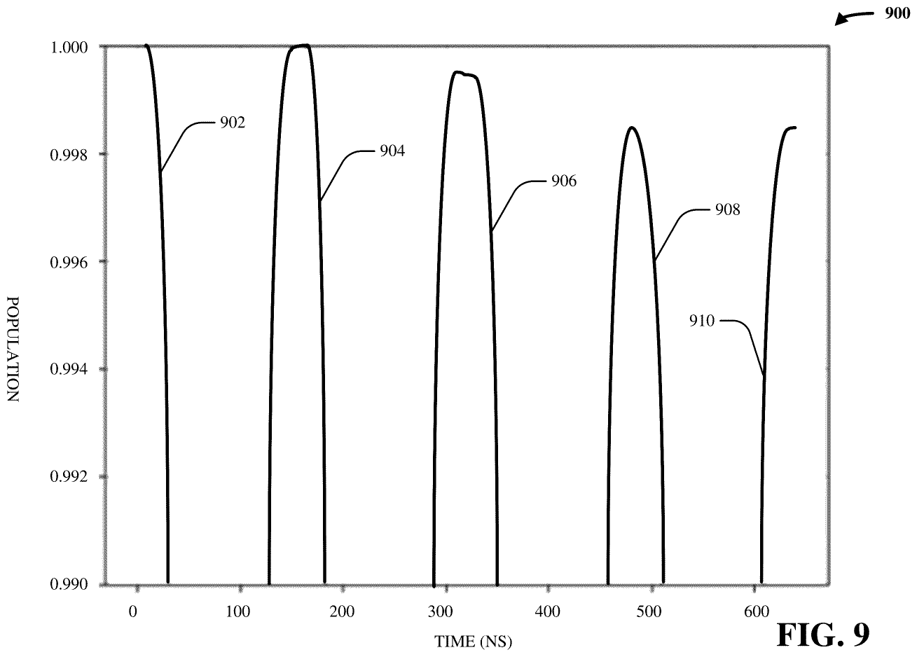

FIGS. 8-9 illustrate example, non-limiting experimental results regarding state transfer induced via mode-switching in accordance with various embodiments described herein.

Consider FIG. 8, which shows a graph 800. The present inventors performed an experiment in which they reduced to practice a real-world embodiment of the system 100. During such experiment, the quantum state 502 was created in the excitation mode 104 of the multi-mode qubit 102 as described with respect to FIG. 5 and was subsequently transferred to the excitation mode 104 of the multi-mode qubit 108 as described with respect to FIGS. 6-7. The graph 800 depicts various microwave pulses that were implemented to facilitate such state transfer. Specifically, the multi-mode qubit 102 was initially in the 1-0 excitation (e.g., such that the quantum state 502 populated or occupied only the excitation mode 104 of the multi-mode qubit 102). Additionally, the multi-mode qubit 108 was initially in the 0-1 excitation with a |0) state (e.g., such that |0) populated or occupied only the excitation mode 106 of the multi-mode qubit 108). A microwave pulse 802 having a peak frequency of about 5 mega Hertz (MHz) was applied to the multi-mode qubit 102, thereby causing the multi-mode qubit 102 to enter the 1-1 excitation (e.g., such that the quantum state 502 populated or occupied both the excitation mode 104 and the excitation mode 106 of the multi-mode qubit 102). A microwave pulse 804 having a peak frequency of about 13 MHz was applied to the multi-mode qubit 102, thereby causing the multi-mode qubit 102 to enter the 0-1 excitation (e.g., such that the quantum state 502 populated or occupied only the excitation mode 106 of the multi-mode qubit 102). At such point, the quantum state 502 was transferred to the excitation mode 106 of the multi-mode qubit 108, due to the above-mentioned triple hybridization. A microwave pulse 806 having a peak frequency of about 11 MHz was applied to the multi-mode qubit 108, thereby causing the multi-mode qubit 108 to enter the 1-1 excitation (e.g., such that the quantum state 502 populated or occupied both the excitation mode 104 and the excitation mode 106 of the multi-mode qubit 108). A microwave pulse 808 having a peak frequency of about 4 MHz was applied to the multi-mode qubit 108, thereby causing the multi-mode qubit 102 to enter the 1-0 excitation (e.g., such that the quantum state 502 populated or occupied only the excitation mode 104 of the multi-mode qubit 102).

Next, consider FIG. 9, which shows a graph 900. During the above experiment, the present inventors measured the energy content or population of various pieces of hardware at various intermediate points in time. Numeral 902 shows the measured population of the excitation mode 104 of the multi-mode qubit 102 when the quantum state 502 populated or occupied only the excitation mode 104 of the multi-mode qubit 102. Numeral 904 shows the measured population of the excitation mode 106 of the multi-mode qubit 102 when the quantum state 502 populated or occupied both the excitation mode 104 and the excitation mode 106 of the multi-mode qubit 102. Numeral 906 shows the measured population of the excitation mode 106 of the multi-mode qubit 108 when the quantum state 502 populated or occupied only the excitation mode 106 of the multi-mode qubit 102 and, due to triple hybridization, only the excitation mode 106 of the multi-mode qubit 108. Numeral 908 shows the measured population of the excitation mode 104 of the multi-mode qubit 108 when the quantum state 502 populated or occupied both the excitation mode 104 and the excitation mode 106 of the multi-mode qubit 108. Numeral 910 shows the measured population of the excitation mode 104 of the multi-mode qubit 108 when the quantum state 502 populated or occupied only the excitation mode 104 of the multi-mode qubit 108. As shown, the quantum state 502 was transferred from the multi-mode qubit 102 to the multi-mode qubit 108 with a fidelity of about 99.8%. This is an extraordinarily high fidelity for a state transfer between two qubits that are about 1 meter apart.

In various aspects, the pulses shown in the graph 800 can be temporally overlapping, so as to shorten a total amount of time required to facilitate a quantum state transfer. In some instances, such temporal overlapping can be facilitated via derivative removal by adiabatic gate (DRAG) pulses.

Although FIGS. 4-9 pertain to embodiments in which a quantum state transfer is facilitated via intermediate population of the 1-1 excitation, these are mere non-limiting examples for ease of explanation and illustration. In some embodiments, the 1-1 excitation can be skipped, such as by implementing pulses via stimulated Raman adiabatic passage (STIRAP).

Although FIGS. 4-9 pertain to embodiments in which a quantum state transfer is facilitated by causing both the multi-mode qubit 102 and the multi-mode qubit 108 to be encoded in the excitation mode 106, these are mere non-limiting examples. Indeed, in various embodiments, a functionally equivalent quantum state transfer can be facilitated by keeping both the multi-mode qubit 102 and the multi-mode qubit 108 encoded in the excitation mode 104 and by instead causing the cable 110 to cease exhibiting the dipole moment symmetry 107 and to instead exhibit the dipole moment symmetry 105.

More specifically, suppose that the multi-mode qubit 102 is initially encoded in the excitation mode 104, such that the quantum state 502 populates or occupies only the excitation mode 104. Furthermore, suppose that the multi-mode qubit 108 is initially encoded in the excitation mode 104, such that its initial |0) state populates or occupies only the excitation mode 104. At such point, both the multi-mode qubit 102 and the multi-mode qubit 108 can exhibit the dipole moment symmetry 105, where the cable 110 can instead exhibit the dipole moment symmetry 107. Because of such dipole moment symmetry mismatch, there can be no (or nearly no) communication or interaction between the multi-mode qubit 102, the cable 110, and the multi-mode qubit 108.

Now, the signal generator 112 can expose the cable 110 to any suitable microwave pulses or other electromagnetic signals, so as to cause the cable 110 to exhibit the dipole moment symmetry 105 rather than the dipole moment symmetry 107. As a non-limiting example, prior to such microwave pulses or electromagnetic signals, the conductor 212 can presently be positively charged while the conductor 214 and the conductor 216 can presently be negatively charged. However, after such microwave pulses or electromagnetic signals, the conductor 212 can be neutrally charged, the conductor 214 can be positively charged, and the conductor 216 can be negatively charged. Accordingly, triple hybridization as described above can occur, such that the multi-mode qubit 102 and the multi-mode qubit 108 can communicate or interact with each other with no or nearly no loss contributed by the cable 110. Such triple hybridization can cause the quantum state 502 to transmit or propagate across the cable 110 toward the multi-mode qubit 108. Upon reaching the multi-mode qubit 108, the quantum state 502 can be considered as combining with whatever current or present quantum state is stored in or represented by the multi-mode qubit 108. Since that current or present quantum state is |0), such combination can cause the multi-mode qubit 108 to now store or represent (in the excitation mode 104) the quantum state 502 (e.g., adding the quantum state 502 to |0) can yield the quantum state 502). Simultaneously, the triple hybridization mentioned above can cause the |0) state stored or represented in the multi-mode qubit 108 to counter-transmit or counter-propagate across the cable 110 toward the multi-mode qubit 102. Upon reaching the multi-mode qubit 102, that |0) state can be considered as combining with whatever current or present quantum state is stored in or represented by the multi-mode qubit 102. Since that current or present quantum state is the quantum state 502, such combination can cause the multi-mode qubit 102 to still store or represent (in the excitation mode 104) the quantum state 502 (e.g., adding |0) to the quantum state 502 can yield the quantum state 502).

At this point, the signal generator 112 can expose the cable 110 to any suitable microwave pulses or other electromagnetic signals, so as to cause the cable 110 to exhibit the dipole moment symmetry 107 rather than the dipole moment symmetry 105. This can disrupt the above-mentioned triple hybridization, such that the multi-mode qubit 102, the multi-mode qubit 108, and the cable 110 are no longer able to communicate or interact with each other. Thus, the quantum state 502 can be considered as having been transferred from the multi-mode qubit 102 to the multi-mode qubit 108, without the multi-mode qubit 102 or the multi-mode qubit 108 being driven at all (e.g., by just switching the dipole moment symmetry of the cable 110). After the quantum state 502 populates the excitation mode 104 of the multi-mode qubit 108, any desired quantum gates or transformations can be locally applied to the multi-mode qubit 108.

FIG. 10 illustrates an example, non-limiting structural diagram 1000 showing how a tunable coupler qubit having superconducting quantum interference device (SQUID) loops instead of single Josephson junctions can be leveraged to facilitate a state transfer in accordance with one or more embodiments described herein.

Just as described above, the cable 110 can be made up of the conductor 212, the conductor 214, and the conductor 216 and can exhibit the dipole moment symmetry 107, whereas the multi-mode qubit 102 can be made up of the capacitor pad 206, the capacitor pad 208, and the capacitor pad 210 and can exhibit the dipole moment symmetry 105.

In various embodiments, as shown, the Josephson junction 202 can be replaced with a SQUID loop 1002. In various aspects, the SQUID loop 1002 can be considered as a pair of Josephson junctions that are coupled in parallel with each other and that are collectively shunted by the capacitor pad 206 and the capacitor pad 208. In various cases, the SQUID loop 1002 can be fabricated or manufactured via any suitable microfabrication or nanofabrication techniques so as to have any suitable size, shape, or dimensionality. Additionally, the SQUID loop 1002 can be fabricated or manufactured from any suitable superconducting materials or combinations of superconducting materials as desired.

Likewise, as shown, the Josephson junction 204 can be replaced with a SQUID loop 1004. In various aspects, the SQUID loop 1004 can be considered as a pair of Josephson junctions that are coupled in parallel with each other and that are collectively shunted by the capacitor pad 208 and the capacitor pad 210. In various cases, the SQUID loop 1004 can be fabricated or manufactured via any suitable microfabrication or nanofabrication techniques so as to have any suitable size, shape, or dimensionality. Additionally, the SQUID loop 1004 can be fabricated or manufactured from any suitable superconducting materials or combinations of superconducting materials as desired.

Although FIG. 10 depicts the SQUID loop 1002 and the SQUID loop 1004 as being identical to each other (e.g., as being identically-sized or as being identically-structured), this is a mere non-limiting example for ease of illustration. In various aspects, the SQUID loop 1002 and the SQUID loop 1004 can have the same or different sizes, shapes, spatial dimensions, or material compositions as each other.

In any case, the SQUID loop 1002 and the SQUID loop 1004 can be considered as exhibiting respective inductances. The inductance of the SQUID loop 1002 can be controllably changed, altered, adjusted, increased, decreased, or otherwise modulated by selectively applying a magnetic flux to or orthogonally through the SQUID loop 1002, where the extent or degree of such change, alteration, adjustment, increase, decrease, or modulation can depend upon the strength, magnitude, frequency, or direction of the applied magnetic flux. Similarly, the inductance of the SQUID loop 1004 can be controllably changed, altered, adjusted, increased, decreased, or otherwise modulated by selectively applying a magnetic flux to or orthogonally through the SQUID loop 1004, where the extent or degree of such change, alteration, adjustment, increase, decrease, or modulation can depend upon the strength, magnitude, frequency, or direction of that applied magnetic flux.

In some situations, the SQUID loop 1002 and the SQUID loop 1004 can be caused (e.g., via fabrication or via application of respective magnetic fluxes) to have identical inductances as each other. That is, magnetic fluxes can be used so as to cause the inductance of the SQUID loop 1002 to be balanced with or equal to the inductance of the SQUID loop 1004. In other situations, however, the SQUID loop 1002 and the SQUID loop 1004 can be caused (e.g., via application of respective magnetic fluxes) to have non-identical or different inductances as each other. That is, magnetic fluxes can be used so as to cause the inductance of the SQUID loop 1002 to be unbalanced with or unequal to the inductance of the SQUID loop 1004. When the inductance of the SQUID loop 1002 is balanced with that of the SQUID loop 1004, there can be no (or nearly no) coupling between the multi-mode qubit 102 and the cable 110, due to mismatching dipole moment symmetries. In contrast, when the inductance of the SQUID loop 1002 is unbalanced with that of the SQUID loop 1004, there can be lossless (or nearly lossless) coupling between the multi-mode qubit 102 and the cable 110, notwithstanding the multi-mode qubit 102 being in the excitation mode 104. In other words, the multi-mode qubit 102 can be forced to communicate or interact with the cable 110 when it is encoded in the excitation mode 104, by de-balancing the inductances of the SQUID loop 1002 and the SQUID loop 1004. In various aspects, such de-balancing can be controllably facilitated by the signal generator 112 (e.g., any suitable transmission lines can run from the signal generator 112 to the multi-mode qubit 102 such that propagation of microwave pulses along those transmission lines respectively cause magnetic fluxes to flow orthogonally through the SQUID loop 1002 or the SQUID loop 1004).

Although not explicitly shown, it should be understood or otherwise appreciated that implementation of SQUID loops rather than single Josephson junctions can be applied to the multi-mode qubit 108.

So, in situations where the Josephson junctions of the multi-mode qubit 102 and of the multi-mode qubit 108 are outfitted with SQUID loops, the signal generator 112 can perform or otherwise facilitate a state transfer from the multi-mode qubit 102 to the multi-mode qubit 108 via inductance de-balancing.

Specifically, suppose that the multi-mode qubit 102 is initially encoded in the excitation mode 104, such that the quantum state 502 populates or occupies only the excitation mode 104. Furthermore, suppose that the SQUID loop inductances of the multi-mode qubit 102 are balanced. Because the multi-mode qubit 102 can, at such point, exhibit the dipole moment symmetry 105, there can be a mismatch between the dipole moment symmetry of the multi-mode qubit 102 and that of the cable 110. So, there can accordingly be no (or nearly no) communication or interaction between the multi-mode qubit 102 and the cable 110.

Next, the signal generator 112 can expose the SQUID loops of the multi-mode qubit 102 to respective magnetic fluxes, so as to de-balance their inductances. Although the multi-mode qubit 102 can still be encoded in the excitation mode 104, such de-balancing can cause the dipole moment symmetry of the multi-mode qubit 102 to become more like (though not necessarily identical to) that of the cable 110. Thus, there can be at least some communication or interaction between the multi-mode qubit 102 and the cable 110, notwithstanding the multi-mode qubit 102 still being encoded in the excitation mode 104.

Just as above, the multi-mode qubit 108 can be encoded in the excitation mode 104, and it can be equipped with SQUID loops rather than single Josephson junctions. In various aspects, the signal generator 112 can expose the SQUID loops of the multi-mode qubit 108 to respective magnetic fluxes, so as to de-balance their inductances. Although the multi-mode qubit 108 can still be encoded in the excitation mode 104, such de-balancing can cause the dipole moment symmetry of the multi-mode qubit 108 to become more like (though not necessarily identical to) that of the cable 110. Thus, there can be at least some communication or interaction between the multi-mode qubit 108 and the cable 110, notwithstanding the multi-mode qubit 108 still being encoded in the excitation mode 104.

Now, suppose that the quantum state (which is currently or presently populating or occupying the excitation mode 104) of the multi-mode qubit 108 is |0). In such case, the inductance de-balancing mentioned above can cause triple hybridization to at least partially occur among the multi-mode qubit 102, the multi-mode qubit 108, and the cable 110. Such triple hybridization can cause the quantum state 502 to transmit or propagate across the cable 110 toward the multi-mode qubit 108. Upon reaching the multi-mode qubit 108, the quantum state 502 can be considered as combining with whatever current or present quantum state is stored in or represented by the multi-mode qubit 108. Since that current or present quantum state is |0), such combination can cause the multi-mode qubit 108 to now store or represent (in the excitation mode 104) the quantum state 502 (e.g., adding the quantum state 502 to |0) can yield the quantum state 502). Simultaneously, the triple hybridization mentioned above can cause the |0) state stored or represented in the multi-mode qubit 108 to counter-transmit or counter-propagate across the cable 110 toward the multi-mode qubit 102. Upon reaching the multi-mode qubit 102, that |0) state can be considered as combining with whatever current or present quantum state is stored in or represented by the multi-mode qubit 102. Since that current or present quantum state is the quantum state 502, such combination can cause the multi-mode qubit 102 to still store or represent (in the excitation mode 104) the quantum state 502 (e.g., adding |0) to the quantum state 502 can yield the quantum state 502).

At this point, the signal generator 112 can re-balance the inductances of the SQUID loops of the multi-mode qubit 102 and of the SQUID loops of the multi-mode qubit 108, thereby cutting off or ceasing communication or interaction between the multi-mode qubit 102 and the multi-mode qubit 108. After the quantum state 502 populates the excitation mode 104 of the multi-mode qubit 108, any desired quantum gates or transformations can be locally applied to the multi-mode qubit 108.

Accordingly, by balancing and de-balancing SQUID loop inductances as described with respect to FIG. 10, the signal generator 112 can be considered as transferring the quantum state 502 from the multi-mode qubit 102 to the multi-mode qubit 108, notwithstanding that the multi-mode qubit 102 and the multi-mode qubit 108 are on the order of one meter apart. Furthermore, the present inventors experimentally verified that such state transfer can occur with nearly no loss.

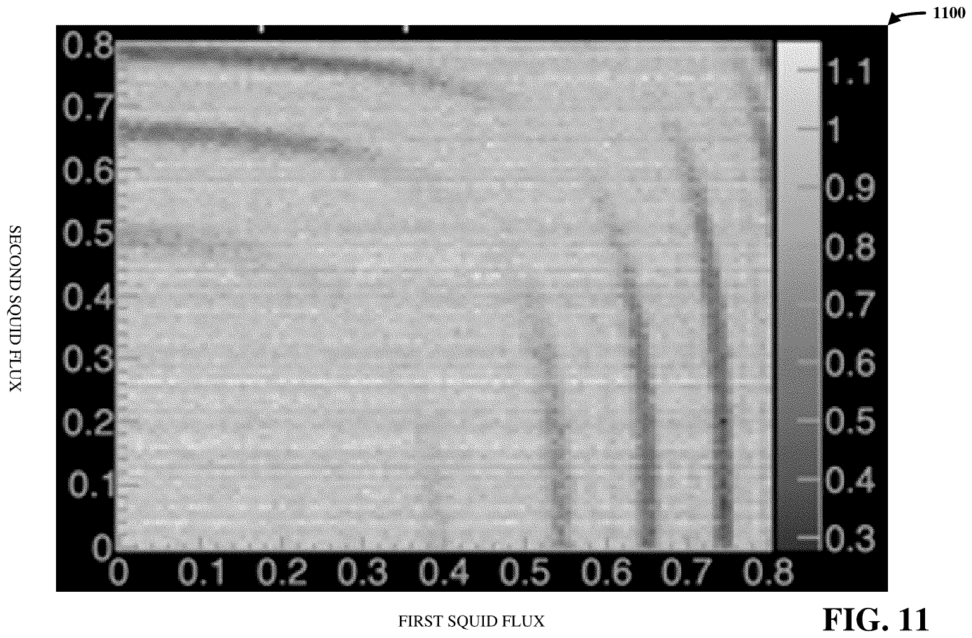

FIGS. 11-14 illustrate example, non-limiting experimental results regarding state transfer induced via SQUID loop de-balancing in accordance with various embodiments described herein.

First, consider FIG. 11, which shows a graph 1100. The present inventors performed an experiment in which they reduced to practice a real-world embodiment of the multi-mode qubit 102 and the cable 110, in which SQUID loops are implemented instead of single Josephson junctions. During such experiment, the multi-mode qubit 108 was omitted. Also during such experiment, the multi-mode qubit 102 was encoded in the excitation mode 104, and the energy content or population of the multi-mode qubit 102 was measured (in relative or unitless fashion) as the inductances of the SQUID loop 1002 and of the SQUID loop 1004 were independently changed via applied magnetic fluxes. In such experiments, the SQUID loop 1002 and the SQUID loop 1004 were identically designed, such that they would respond to the same applied flux in the same way (e.g., such that they would be balanced in the absence of applied fluxes). The graph 1100 depicts measured energy content or population as a function of SQUID flux. More specifically, the horizontal axis of the graph 1100 represents voltage that was used to generate a magnetic flux for the first SQUID loop (e.g., 1002) of the multi-mode qubit 102, and the vertical axis of the graph 1100 represents voltage that was used to generate a magnetic flux for the second SQUID loop (e.g., 1004) of the multi-mode qubit 102. Brighter shades in the graph 1100 denote higher energy contents, and darker shades in the graph 1100 denote lower energy contents. In other words, brighter shades in the graph 1100 indicate that the quantum state was contained within the multi-mode qubit 102, whereas darker shades in the graph 1100 indicate that the quantum state left the multi-mode qubit 102 to occupy the only other entity involved in that experiment: the cable 110. As shown in the graph 1100, the multi-mode qubit 102 exhibited vacuum rabi oscillations (e.g., oscillated from bright shades to dark shades) when unbalanced (e.g., unequal) magnetic fluxes were applied to the SQUID loops of the multi-mode qubit 102. As also shown, the multi-mode qubit 102 did not exhibit vacuum rabi oscillations (e.g., instead remained in the bright shades) when balanced (e.g., equal) magnetic fluxes were applied to the SQUID loops of the multi-mode qubit 102. Specifically, a diagonal line that extends from the bottom left to the upper right of the graph 1100 can be considered as denoting balanced or equal magnetic fluxes. Note how no dark shades occur on that diagonal line. In contrast, when magnetic fluxes that are not on that diagonal line are applied, note how the bright and dark shades begin to oscillate. This experimentally verifies that electromagnetic coupling occurred between the multi-mode qubit 102 and the cable 110 notwithstanding the multi-mode qubit 102 being encoded in the excitation mode 104, and this experimentally verifies that such electromagnetic coupling was caused by de-balancing the inductances of the SQUID loops of the multi-mode qubit 102.

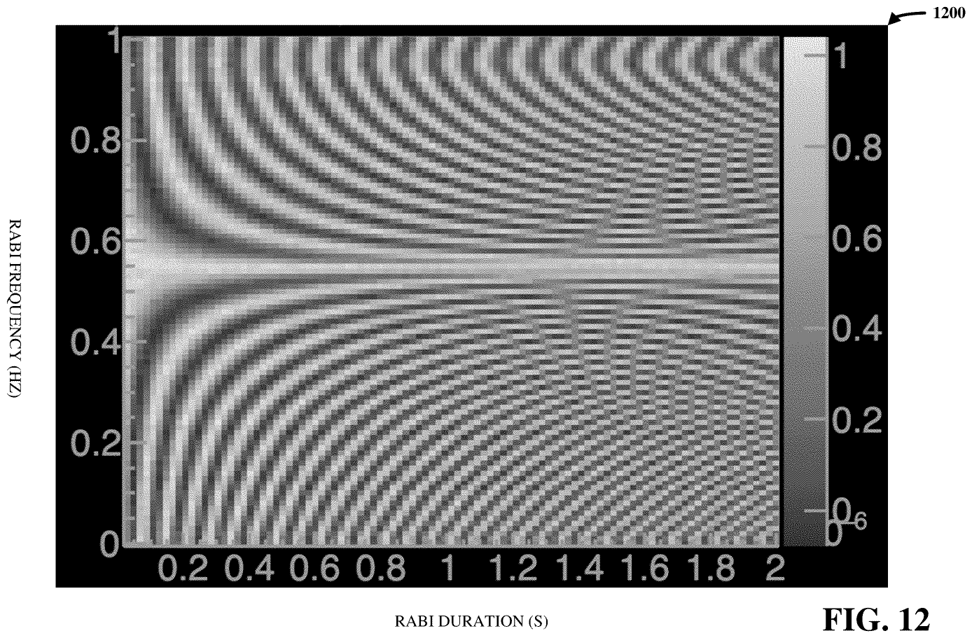

Next, consider FIG. 12, which shows a graph 1200. The graph 1200 is an alternative visualization of vacuum rabi oscillations exhibited by the multi-mode qubit 102 when encoded in the excitation mode 104. Rather than showing measured energy content as a function of applied magnetic fluxes, the graph 1200 instead shows measured energy content as a function of rabi duration (e.g., length of time in seconds for which a magnetic flux is applied) and rabi frequency (e.g., frequency in Hz of an applied magnetic flux). Just as above, brighter shades in the graph 1200 denote higher energy contents (meaning that the quantum state was present in the multi-mode qubit 102), whereas darker shades in the graph 1200 denote lower energy contents (e.g., meaning that the quantum state left the multi-mode qubit 102 and instead was present in the cable 110).

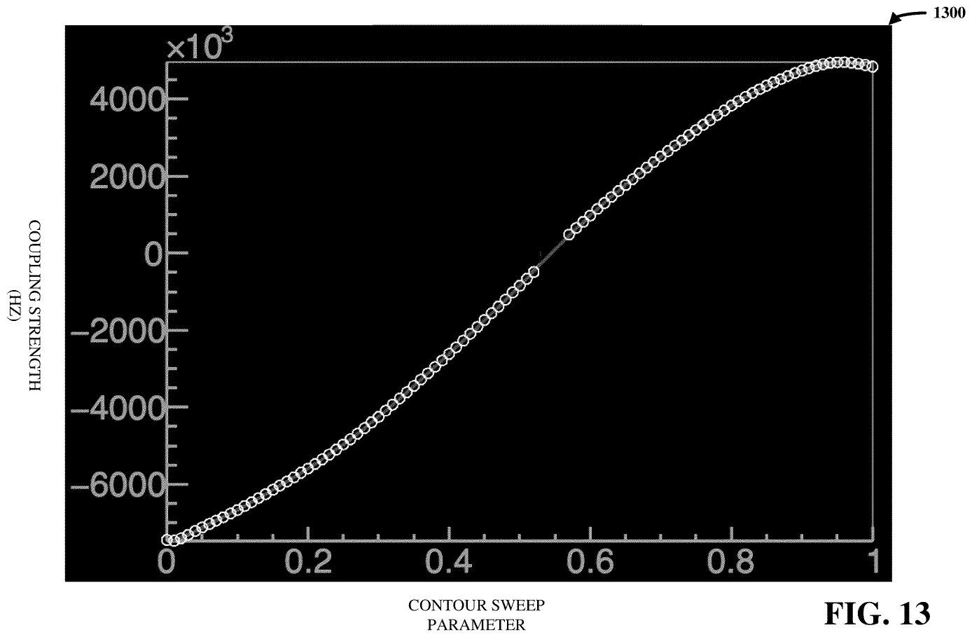

Now, consider FIG. 13, which shows a graph 1300. The graph 1300 shows measured coupling strength (in units of Hz) between the multi-mode qubit 102 and the cable 110 as a function of rabi frequency. Note that the horizontal axis of the graph 1300, termed a contour sweep parameter, was configured to be the same as the vertical axis of the graph 1200 (e.g., was configured to represent rabi frequency). As shown in the graph 1300, the coupling strength between the multi-mode qubit 102 and the cable 110 varies continuously with rabi frequency. Accordingly, the graph 1200 and the graph 1300 can be considered as collectively showing that the following two quantities can be independently controllable or tunable: the de-balancing of the SQUID loop inductances of the multi-mode qubit 102; and the resulting coupling strength between the multi-mode qubit 102 and the cable 110. Thus, state transfer via inductance de-balancing can be considered as a highly controllable technique.

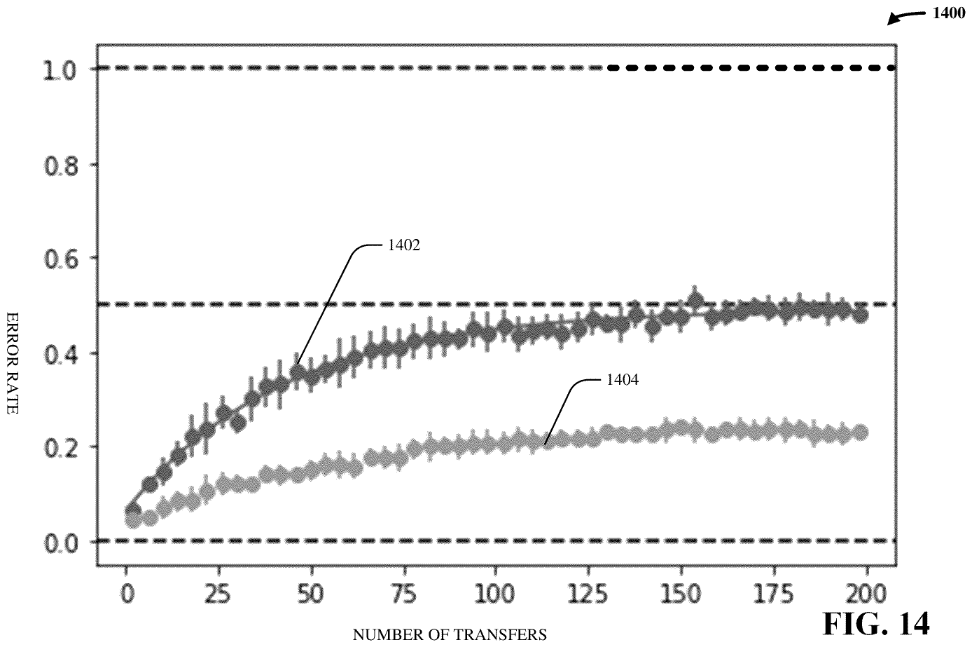

Next, consider FIG. 14, which shows a graph 1400. The present inventors performed an experiment in which they reduced to practice a real-world embodiment of the multi-mode qubit 102, the cable 110, and the multi-mode qubit 108, in which SQUID loops were implemented instead of single Josephson junctions. During such experiment, a quantum state was initialized in the excitation mode 104 of one of the multi-mode qubits and was then transferred back and forth between the two multi-mode qubits via inductance de-balancing a plurality of times. After each individual transfer, the fidelities of both multi-mode qubits were measured and were subtracted from 1 (from 100%), so as to yield a respective transfer error for each of the two multi-mode qubits. The graph 1400 shows those transfer errors as a function of number of transfers. In particular, numeral 1402 shows the transfer errors computed for the multi-mode qubit 102, and the numeral 1404 shows the transfer errors computed for the multi-mode qubit 108. Using the graph 1400, it was estimated that a single quantum state transfer performed via inductance de-balancing has a fidelity of about 98%. This experiment verifies that quantum state transfer via inductance de-balancing can be considered as nearly lossless.

FIG. 15 illustrates an example, non-limiting block diagram 1500 showing how fully remote quantum gates can be accomplished via cable driving in accordance with one or more embodiments described herein.

Thus far, the herein disclosure has mainly described with respect to the figures various embodiments in which the signal generator 112 can facilitate or perform a quantum state transfer between the multi-mode qubit 102 and the multi-mode qubit 108. However, in other embodiments, the signal generator 112 can instead facilitate or perform any other suitable type of quantum interaction between the multi-mode qubit 102 and the multi-mode qubit 108. As a non-limiting example, the signal generator 112 can, in various aspects, facilitate or perform a fully remote quantum gate on the multi-mode qubit 102 and the multi-mode qubit 108.

A fully remote quantum gate can be considered as a quantum gate that transforms the quantum state of a qubit, without that qubit having to be exposed to or driven by any microwave pulse. In other words, a fully remote quantum gate can be a quantum gate that transforms the state of a given qubit but that does not require any local interaction with that given qubit.

In various embodiments, the signal generator 112 can perform or facilitate a fully remote quantum gate via cable driving. Specifically, suppose that the multi-mode qubit 102 is encoded in the excitation mode 106 (e.g., is in the 0-1 excitation), and suppose that the multi-mode qubit 108 is also encoded in the excitation mode 106 (e.g., is also in the 0-1 excitation). Alternatively, suppose that the multi-mode qubit 102 is encoded in the excitation mode 104 but is made up of SQUID loops whose inductances are de-balanced, and suppose that the multi-mode qubit 108 is also encoded in the excitation mode 104 but is made up of SQUID loops whose inductances are de-balanced. In either situation, as described above, the multi-mode qubit 102 and the multi-mode qubit 108 can communicate or interact with nearly no loss through the cable 110. In various aspects, the signal generator 112 can controllably transmit a microwave pulse to the cable 110, but can refrain from transmitting any pulses to the multi-mode qubit 102 or to the multi-mode qubit 108. In other words, the signal generator 112 can drive the cable 110 alone with the microwave pulse. In various instances, as described above, the quantum states of the multi-mode qubit 102 and of the multi-mode qubit 108 can be considered as propagating and counter-propagating in nearly lossless fashion through the cable 110 to and from the multi-mode qubit 102 and the multi-mode qubit 108. So, upon being exposed to the microwave pulse as they are propagating and counter-propagating through the cable 110, those quantum states can undergo whatever gate or transformation corresponds to the frequency of that microwave pulse. In various aspects, those transformed states (rather than the original quantum states) can now be considered as propagating and counter-propagating through the cable 110 to and from the multi-mode qubit 102 and the multi-mode qubit 108. In other words, the quantum states that are represented by the multi-mode qubit 102 and the multi-mode qubit 108 can have been transformed by a quantum gate, even though neither the multi-mode qubit 102 nor the multi-mode qubit 108 was exposed to or driven by a local microwave pulse. In still other words, a fully remote quantum gate can be applied to the multi-mode qubit 102 and the multi-mode qubit 108, by driving the cable 110 rather than the multi-mode qubit 102 and the multi-mode qubit 108.

FIG. 16 illustrates example, non-limiting experimental results regarding remote quantum gates performed via cable driving in accordance with various embodiments described herein.

FIG. 16 shows a graph 1600. The present inventors conducted an experiment in which a fully remote quantum gate was performed as described with respect to FIG. 15: that is, by driving the cable 110 with a microwave pulse. During such experiment, a concurrence of the fully remote quantum gate was measured across a range of amperages for the microwave pulse. Numeral 1604 in the graph 1600 shows those measured concurrence values as a function of drive amplitude. Numeral 1602 represents that the polarization (e.g., dipole moment symmetry) of the cable 110 was constant throughout such experiment. As shown, a concurrence of 1 is achievable. This experiment helps to demonstrate the efficacy of performing fully remote quantum gates via cable driving.

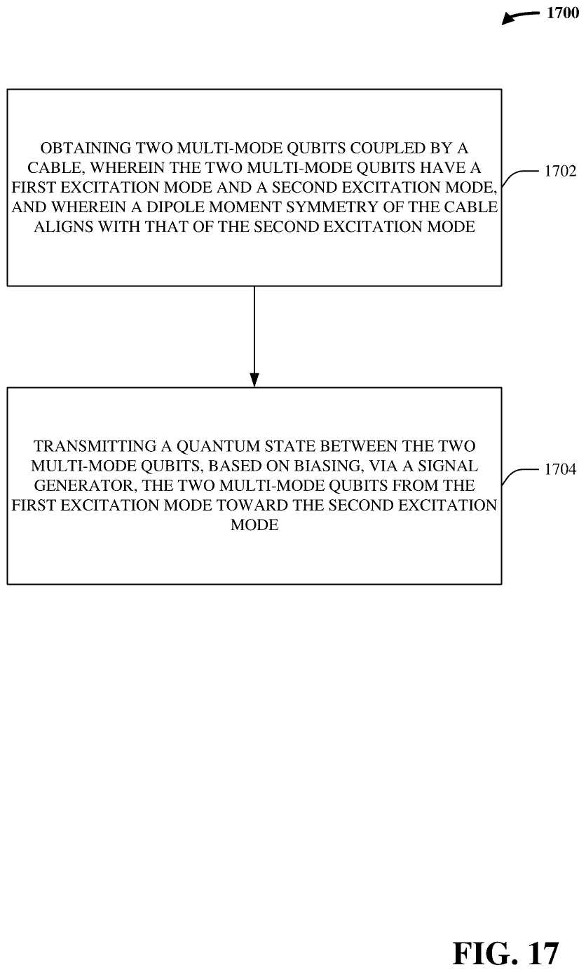

FIG. 17 illustrates a flow diagram of an example, non-limiting method 1700 that can facilitate long-range quantum interactions via multi-mode qubits in accordance with one or more embodiments described herein.

In various embodiments, act 1702 can include obtaining two multi-mode qubits (e.g., 102 and 108) that are coupled by a cable (e.g., 110). In various aspects, the two multi-mode qubits can have a first excitation mode (e.g., 104) and a second excitation mode (e.g., 106). In various instances, a dipole moment symmetry (e.g., 107) of the cable can align (e.g., can match, can be the same as or similar to) that of the second excitation mode.

In various aspects, act 1704 can include transmitting a quantum state (e.g., 502) between the two multi-mode qubits, based on biasing, via a signal generator (e.g., 112), the two multi-mode qubits from the first excitation mode toward (although not necessarily completely to) the second excitation mode.

Although not explicitly shown in FIG. 17, each of the two multi-mode qubits can be a tunable coupler qubit whose planar capacitor pads (e.g., 206, 208, 210) are coupled by single Josephson junctions (e.g., 202, 204). In various aspects, prior to the biasing, the two multi-mode qubits can be encoded in the first excitation mode, and the signal generator can bias the two multi-mode qubits based on: switching the two multi-mode qubits from the first excitation mode to the second excitation mode via one or more microwave pulses, thereby yielding a triply-hybridized dipole moment symmetry across the cable (e.g., as described with respect to FIGS. 4-9).

Although not explicitly shown in FIG. 17, each of the two multi-mode qubits can be a tunable coupler qubit whose planar capacitor pads (e.g., 206, 208, 210) are coupled by SQUID loops (e.g., 1002, 1004). In various instances, prior to the biasing, the two multi-mode qubits can be encoded in the first excitation mode and can have balanced SQUID loop inductances, and the signal generator can bias the two multi-mode qubits based on: de-balancing the SQUID loop inductances via one or more magnetic fluxes, thereby yielding a triply-hybridized dipole moment symmetry across the cable (e.g., as described with respect to FIGS. 10-14).

Although not explicitly shown in FIG. 17, the method 1700 can include: driving, via the signal generator, the cable with a microwave pulse, thereby performing a remote quantum gate on both of the two multi-mode qubits (e.g., as described with respect to FIGS. 15-16).

The herein disclosure describes non-limiting examples of various embodiments of the subject innovation. For ease of description or explanation, various portions of the herein disclosure utilize the term “each” when discussing various embodiments of the subject innovation. Such usages of the term “each” are non-limiting examples. In other words, when the herein disclosure provides a description that is applied to “each” of some particular object or component, it should be understood that this is a non-limiting example of various embodiments of the subject innovation, and it should be further understood that, in various other embodiments of the subject innovation, it can be the case that such description applies to fewer than “each” of that particular object or component.

The flowcharts and structures in the Figures illustrate the architecture, functionality, and operation of possible implementations of systems, methods, or computer program products according to various embodiments described herein. In this regard, each block in the flowcharts can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
transmitting a quantum state between two multi-mode qubits having a first excitation mode and a second excitation mode, wherein the two multi-mode qubits are coupled by a cable whose dipole moment symmetry aligns with that of the second excitation mode, wherein the transmitting comprises:
biasing, via a signal generator, the two multi-mode qubits from the first excitation mode toward the second excitation mode.

2. The method of claim 1, wherein each of the two multi-mode qubits is a tunable coupler qubit whose planar capacitor pads are coupled by single Josephson junctions.

3. The method of claim 2, wherein, prior to the biasing, the two multi-mode qubits are encoded in the first excitation mode, and wherein the signal generator biases the two multi-mode qubits based on:
switching the two multi-mode qubits from the first excitation mode to the second excitation mode via one or more microwave pulses, thereby yielding a triply-hybridized dipole moment symmetry across the cable.

4. The method of claim 1, wherein each of the two multi-mode qubits is a tunable coupler qubit whose planar capacitor pads are coupled by superconductive quantum interference device (SQUID) loops.

5. The method of claim 4, wherein, prior to the biasing, the two multi-mode qubits are encoded in the first excitation mode and have balanced SQUID loop inductances, and wherein the signal generator biases the two multi-mode qubits based on:
de-balancing the SQUID loop inductances via one or more magnetic fluxes, thereby yielding a triply-hybridized dipole moment symmetry across the cable.

6. The method of claim 1, further comprising:
driving, via the signal generator, the cable with a microwave pulse, thereby performing a remote quantum gate on both of the two multi-mode qubits.

7. The method of claim 1, wherein the cable is a coplanar waveguide or a coaxial channel.

8. The method of claim 1, wherein the cable is capacitively or galvanically coupled to the two multi-mode qubits.

9. The method of claim 1, wherein the cable is at least one meter in length.

10. A device, comprising:
two multi-mode qubits coupled by a cable, wherein the two multi-mode qubits have a first excitation mode and a second excitation mode, and wherein a dipole moment symmetry of the cable aligns with that of the second excitation mode; and
a signal generator that transmits a quantum state between the two multi-mode qubits, based on biasing the two multi-mode qubits from the first excitation mode toward the second excitation mode.

11. The device of claim 10, wherein each of the two multi-mode qubits is a tunable coupler qubit whose planar capacitor pads are coupled by single Josephson junctions.

12. The device of claim 11, wherein, prior to the biasing, the two multi-mode qubits are encoded in the first excitation mode, and wherein the signal generator biases the two multi-mode qubits based on:
switching the two multi-mode qubits from the first excitation mode to the second excitation mode via one or more microwave pulses, thereby yielding a triply-hybridized dipole moment symmetry across the cable.

13. The device of claim 10, wherein each of the two multi-mode qubits is a tunable coupler qubit whose planar capacitor pads are coupled by superconductive quantum interference device (SQUID) loops.

14. The device of claim 13, wherein, prior to the biasing, the two multi-mode qubits are encoded in the first excitation mode and have balanced SQUID loop inductances, and wherein the signal generator biases the two multi-mode qubits based on:
de-balancing the SQUID loop inductances via one or more magnetic fluxes, thereby yielding a triply-hybridized dipole moment symmetry across the cable.

15. The device of claim 10, wherein the signal generator drives the cable with a microwave pulse, thereby performing a remote quantum gate on both of the two multi-mode qubits.

16. The device of claim 10, wherein the cable is a coplanar waveguide or a coaxial channel.

17. The device of claim 10, wherein the cable is capacitively or galvanically coupled to the two multi-mode qubits.

18. The device of claim 10, wherein the cable is at least one meter in length.

19. A method, comprising:
transmitting a quantum state between two multi-mode qubits having a first excitation mode and a second excitation mode, wherein the two multi-mode qubits are coupled by a cable whose dipole moment symmetry aligns with that of the second excitation mode, wherein the transmitting comprises:
switching, via a signal generator, the dipole moment symmetry of the cable such that it aligns with that of the first excitation mode.

20. The method of claim 19, wherein the cable is a coplanar waveguide or a coaxial channel.
